(19) United States
(12) Patent Application Publication
(10) Pub. No.: US 2022/0137641 A1
(43) Pub. Date: May 5, 2022

(54) METHOD, APPARATUS, AND COMPUTER PROGRAM PRODUCT FOR GENERATING AN AUTONOMOUS DRIVING PROFILE MAP INDEX

(71) Applicant: HERE Global B.V., Eindhoven (NL)

(72) Inventors: Leon Stenneth, Chicago, IL (US); Jeremy Michael Young, Chicago, IL (US); Jerome Beaurepaire, Berlin (DE)

(21) Appl. No.: 17/089,399

(22) Filed: Nov. 4, 2020

(51) Int. Cl. G05D 1/02; G05D 1/00; G01C 21/00

(52) U.S. Cl. CPC G05D 1/0291; G05D 1/0231; G05D 2201/0213; G05D 1/0212; G01C 21/3804; G05D 1/0088

(57) ABSTRACT

A method, apparatus and computer program product are provided for generating an autonomous driving profile map index. In this regard, vehicle context data and location data thereof associated with a vehicle traveling along a road segment is received. The vehicle context data is determined based on a transition into a platooning driving profile for the vehicle that establishes a communication connection between the vehicle and another vehicle traveling along the road segment. Furthermore, autonomous driving profile data for the vehicle at the road segment associated with the location data is calculated based on the vehicle context data.

### TECHNOLOGICAL FIELD

An example embodiment of the present disclosure generally relates to autonomous driving for vehicles and, more particularly, to a method, apparatus and computer program product for generating an autonomous driving profile map index for vehicles.

### BACKGROUND

Vehicles are being built with more and more sensors to assist with autonomous driving and/or other vehicle technologies. Generally, sensors of a vehicle related to autonomous driving capture imagery data and/or radar data to assist with the autonomous driving. For instance, image sensors and Light Distancing and Ranging (LiDAR) sensors are popular sensor types for identifying objects along a road segment and establishing the safe path of traversal for a vehicle driving autonomously. Autonomous driving capabilities of vehicles are increasing toward full automation (e.g. Level 5 autonomy) with zero human interaction. However, there are numerous challenges related to autonomous driving capabilities of vehicles.

### BRIEF SUMMARY

A method, apparatus and computer program product are provided in order to provide an automated driving profile map index for vehicles. As such, precision and/or confidence of autonomous driving capabilities and/or profiles for a vehicle can be improved. Furthermore, improved navigation of a vehicle, improved route guidance for a vehicle, improved semi-autonomous vehicle control, and/or improved fully autonomous vehicle control can be provided.

In an example embodiment, a computer-implemented method is provided for generating an autonomous driving profile map index. The computer-implemented method includes receiving vehicle context data and location data thereof associated with a vehicle traveling along a road segment, where the vehicle context data is determined based on a transition into a platooning driving profile for the vehicle that establishes a communication connection between the vehicle and another vehicle traveling along the road segment. The computer-implemented method also includes calculating, based on the vehicle context data, autonomous driving profile data for the vehicle at the road segment associated with the location data. The computer-implemented method also includes encoding the autonomous driving profile data in a database to facilitate an autonomous driving profile prediction for vehicles associated with the road segment.

In an example embodiment, the encoding the autonomous driving profile data in the database includes mapping the autonomous driving profile data onto a map data layer of a high-definition map to facilitate the autonomous driving profile prediction for the vehicles.

In another example embodiment, the computer-implemented method also includes aggregating, based on a spatial reference point associated with the location data, the autonomous driving profile data with other autonomous driving profile data for one or more other vehicles at the spatial reference point to generate aggregated autonomous driving profile data for the road segment. In another example embodiment, the computer-implemented method also includes aggregating, based the location data, the autonomous driving profile data with other autonomous driving profile data for one or more other vehicles at respective spatial reference points associated with the road segment to generate aggregated autonomous driving profile data for the road segment.

In an example embodiment, the calculating the autonomous driving profile data for the vehicle includes calculating the autonomous driving profile data for the vehicle based on probe pattern data associated with a driving path pattern for the vehicle traveling along the road segment. In another example embodiment, the vehicle is a first vehicle and the calculating the autonomous driving profile data for the vehicle includes calculating the autonomous driving profile data for the vehicle based on camera sensor data associated with a second vehicle traveling along the road segment. In another example embodiment, the calculating the autonomous driving profile data for the vehicle includes calculating the autonomous driving profile data for the vehicle based on lane change data associated with detection of a lane change of the vehicle traveling along the road segment. In another example embodiment, the calculating the autonomous driving profile data for the vehicle includes calculating the autonomous driving profile data for the vehicle based on traffic condition data associated with the road segment. In another example embodiment, the calculating the autonomous driving profile data for the vehicle includes calculating the autonomous driving profile data for the vehicle based on weather condition data associated with the road segment. In another example embodiment, the calculating the autonomous driving profile data for the vehicle includes calculating the autonomous driving profile data for the vehicle based on road event data associated with the road segment. In another example embodiment, the calculating the autonomous driving profile data for the vehicle includes applying a weight to different portions of the vehicle context data.

In another example embodiment, an apparatus is configured to generate an autonomous driving profile map index. The apparatus includes processing circuitry and at least one memory including computer program code instructions that are configured to, when executed by the processing circuitry, cause the apparatus to receive vehicle context data and location data thereof associated with a vehicle traveling along a road segment, where the vehicle context data is determined based on a transition into a platooning driving profile for the vehicle that establishes a communication connection between the vehicle and another vehicle traveling along the road segment. The computer program code instructions are also configured to, when executed by the processing circuitry, cause the apparatus to calculate, based on the vehicle context data, autonomous driving profile data for the vehicle at the road segment associated with the location data. The computer program code instructions are also configured to, when executed by the processing circuitry, cause the apparatus to encode the autonomous driving profile data in a database to facilitate an autonomous driving profile prediction for vehicles associated with the road segment.

In an example embodiment, the computer program code instructions are also configured to, when executed by the processing circuitry, cause the apparatus to map the autonomous driving profile data onto a map data layer of a high-definition map to facilitate the autonomous driving profile prediction for the vehicles.

In another example embodiment, the computer program code instructions are also configured to, when executed by the processing circuitry, cause the apparatus to aggregate, based on a spatial reference point associated with the location data, the autonomous driving profile data with other autonomous driving profile data for one or more other vehicles at the spatial reference point to generate aggregated autonomous driving profile data for the road segment. In another example embodiment, the computer program code instructions are also configured to, when executed by the processing circuitry, cause the apparatus to aggregate, based the location data, the autonomous driving profile data with other autonomous driving profile data for one or more other vehicles at respective spatial reference points associated with the road segment to generate aggregated autonomous driving profile data for the road segment.

In an example embodiment, the computer program code instructions are also configured to, when executed by the processing circuitry, cause the apparatus to calculate the autonomous driving profile data for the vehicle based on probe pattern data associated with a driving path pattern for the vehicle traveling along the road segment. In another example embodiment, the vehicle is a first vehicle and the computer program code instructions are also configured to, when executed by the processing circuitry, cause the apparatus to calculate the autonomous driving profile data for the vehicle based on camera sensor data associated with a second vehicle traveling along the road segment. In another example embodiment, the computer program code instructions are also configured to, when executed by the processing circuitry, cause the apparatus to calculate the autonomous driving profile data for the vehicle based on lane change data associated with detection of a lane change of the vehicle traveling along the road segment. In another example embodiment, the computer program code instructions are also configured to, when executed by the processing circuitry, cause the apparatus to calculate the autonomous driving profile data for the vehicle based on traffic condition data associated with the road segment. In another example embodiment, the computer program code instructions are also configured to, when executed by the processing circuitry, cause the apparatus to calculate the autonomous driving profile data for the vehicle based on weather condition data associated with the road segment. In another example embodiment, the computer program code instructions are also configured to, when executed by the processing circuitry, cause the apparatus to calculate the autonomous driving profile data for the vehicle based on road event data associated with the road segment. In another example embodiment, the computer program code instructions are also configured to, when executed by the processing circuitry, cause the apparatus to apply a weight to different portions of the vehicle context data.

In another example embodiment, a computer program product is provided to generate an autonomous driving profile map index. The computer program product includes at least one non-transitory computer readable storage medium having computer-executable program code instructions stored therein with the computer-executable program code instructions including program code instructions configured, upon execution, to receive vehicle context data and location data thereof associated with a vehicle traveling along a road segment, wherein the vehicle context data is determined based on a transition into a platooning driving profile for the vehicle that establishes a communication connection between the vehicle and another vehicle traveling along the road segment. The computer-executable program code instructions are also configured to calculate, based on the vehicle context data, autonomous driving profile data for the vehicle at the road segment associated with the location data. Furthermore, the computer-executable program code instructions are configured to encode the autonomous driving profile data in a database to facilitate an autonomous driving profile prediction for vehicles associated with the road segment.

In an example embodiment, the computer-executable program code instructions are also configured to map the autonomous driving profile data onto a map data layer of a high-definition map to facilitate the autonomous driving profile prediction for the vehicles.

In another example embodiment, the computer-executable program code instructions are also configured to aggregate, based on a spatial reference point associated with the location data, the autonomous driving profile data with other autonomous driving profile data for one or more other vehicles at the spatial reference point to generate aggregated autonomous driving profile data for the road segment. In another example embodiment, the computer-executable program code instructions are also configured to aggregate, based the location data, the autonomous driving profile data with other autonomous driving profile data for one or more other vehicles at respective spatial reference points associated with the road segment to generate aggregated autonomous driving profile data for the road segment.

In an example embodiment, the computer-executable program code instructions are also configured to calculate the autonomous driving profile data for the vehicle based on probe pattern data associated with a driving path pattern for the vehicle traveling along the road segment. In another example embodiment, the vehicle is a first vehicle and the computer-executable program code instructions are also configured to calculate the autonomous driving profile data for the vehicle based on camera sensor data associated with a second vehicle traveling along the road segment. In another example embodiment, the computer-executable program code instructions are also configured to calculate the autonomous driving profile data for the vehicle based on lane change data associated with detection of a lane change of the vehicle traveling along the road segment. In another example embodiment, the computer-executable program code instructions are also configured to calculate the autonomous driving profile data for the vehicle based on traffic condition data associated with the road segment. In another example embodiment, the computer-executable program code instructions are also configured to calculate the autonomous driving profile data for the vehicle based on weather condition data associated with the road segment. In another example embodiment, the computer-executable program code instructions are also configured to calculate the autonomous driving profile data for the vehicle based on road event data associated with the road segment. In another example embodiment, the computer-executable program code instructions are also configured to apply a weight to different portions of the vehicle context data.

In another example embodiment, an apparatus is provided that includes means for receiving vehicle context data and location data thereof associated with a vehicle traveling along a road segment, where the vehicle context data is determined based on a transition into a platooning driving profile for the vehicle that establishes a communication connection between the vehicle and another vehicle traveling along the road segment. The apparatus of this example embodiment also includes means for calculating, based on the vehicle context data, autonomous driving profile data for the vehicle at the road segment associated with the location data. The apparatus of this example embodiment also includes means for encoding the autonomous driving profile data in a database to facilitate an autonomous driving profile prediction for vehicles associated with the road segment.

In an example embodiment, the apparatus also includes means for mapping the autonomous driving profile data onto a map data layer of a high-definition map to facilitate the autonomous driving profile prediction for the vehicles.

In another example embodiment, the apparatus also includes means for aggregating, based on a spatial reference point associated with the location data, the autonomous driving profile data with other autonomous driving profile data for one or more other vehicles at the spatial reference point to generate aggregated autonomous driving profile data for the road segment. In another example embodiment, the apparatus also includes means for aggregating, based the location data, the autonomous driving profile data with other autonomous driving profile data for one or more other vehicles at respective spatial reference points associated with the road segment to generate aggregated autonomous driving profile data for the road segment.

In an example embodiment, the apparatus also includes means for calculating the autonomous driving profile data for the vehicle based on probe pattern data associated with a driving path pattern for the vehicle traveling along the road segment. In another example embodiment, the vehicle is a first vehicle and the apparatus also includes means for calculating the autonomous driving profile data for the vehicle based on camera sensor data associated with a second vehicle traveling along the road segment. In another example embodiment, the apparatus also includes means for calculating the autonomous driving profile data for the vehicle based on lane change data associated with detection of a lane change of the vehicle traveling along the road segment. In another example embodiment, the apparatus also includes means for calculating the autonomous driving profile data for the vehicle based on traffic condition data associated with the road segment. In another example embodiment, the apparatus also includes means for calculating the autonomous driving profile data for the vehicle based on weather condition data associated with the road segment. In another example embodiment, the apparatus also includes means for calculating the autonomous driving profile data for the vehicle based on road event data associated with the road segment. In another example embodiment, the apparatus also includes means for applying a weight to different portions of the vehicle context data.

In an example embodiment, an apparatus is configured to generate an autonomous driving profile map index. The apparatus includes processing circuitry and at least one memory including computer program code instructions that are configured to, when executed by the processing circuitry, cause the apparatus to receive vehicle context data and location data thereof associated with a vehicle traveling along a road segment, where the vehicle context data is determined based on a transition into a platooning driving profile for the vehicle that establishes a communication connection between the vehicle and another vehicle traveling along the road segment. The computer program code instructions are also configured to, when executed by the processing circuitry, cause the apparatus to generate a data point for a map layer associated with the road segment based on the vehicle context data and location data, where the data point indicates the transition into the platooning driving profile for the vehicle. The computer program code instructions are also configured to, when executed by the processing circuitry, cause the apparatus store the data point in a database associated with the map layer, where the map layer comprises the data point and one or more other data points that indicate one or more other locations related to respective autonomous driving transitions for one or more other vehicles.

The computer program code instructions of an example embodiment are also configured to, when executed by the processing circuitry, cause the apparatus to generate the data point for the map layer based on probe pattern data associated with a driving path pattern for the vehicle traveling along the road segment. The computer program code instructions of an example embodiment are also configured to, when executed by the processing circuitry, cause the apparatus to generate the data point for the map layer based on camera sensor data associated with a second vehicle traveling along the road segment. The computer program code instructions of an example embodiment are also configured to, when executed by the processing circuitry, cause the apparatus to generate the data point for the map layer based on lane change data associated with detection of a lane change of the vehicle traveling along the road segment. The computer program code instructions of an example embodiment are also configured to, when executed by the processing circuitry, cause the apparatus to generate the data point for the map layer based on at least one of traffic condition data associated with the road segment, weather condition data associated with the road segment, and road event data associated with the road segment.

In another example embodiment, a computer-implemented method is provided for generating an autonomous driving profile map index. The computer-implemented method includes receiving vehicle context data and location data thereof associated with a vehicle traveling along a road segment, where the vehicle context data is determined based on a transition into a platooning driving profile for the vehicle that establishes a communication connection between the vehicle and another vehicle traveling along the road segment. The computer-implemented method also includes generating a data point for a map layer associated with the road segment based on the vehicle context data and location data, where the data point indicates the transition into the platooning driving profile for the vehicle. The computer-implemented method also includes storing the data point in a database associated with the map layer, where the map layer comprises the data point and one or more other data points that indicate one or more other locations related to respective autonomous driving transitions for one or more other vehicles.

The computer-implemented method of an example embodiment also includes generating the data point for the map layer based on probe pattern data associated with a driving path pattern for the vehicle traveling along the road segment. The computer-implemented method of an example embodiment also includes generating the data point for the map layer based on camera sensor data associated with a second vehicle traveling along the road segment. The computer-implemented method of an example embodiment also includes generating the data point for the map layer based on lane change data associated with detection of a lane change of the vehicle traveling along the road segment. The computer-implemented method of an example embodiment also includes generating the data point for the map layer based on at least one of traffic condition data associated with the road segment, weather condition data associated with the road segment, and road event data associated with the road segment.

In another example embodiment, a computer program product is provided to generate an autonomous driving profile map index. The computer program product includes at least one non-transitory computer readable storage medium having computer-executable program code instructions stored therein with the computer-executable program code instructions including program code instructions configured, upon execution, to receive vehicle context data and location data thereof associated with a vehicle traveling along a road segment, where the vehicle context data is determined based on a transition into a platooning driving profile for the vehicle that establishes a communication connection between the vehicle and another vehicle traveling along the road segment. The computer-executable program code instructions are also configured to generate a data point for a map layer associated with the road segment based on the vehicle context data and location data, where the data point indicates the transition into the platooning driving profile for the vehicle. Furthermore, the computer-executable program code instructions are configured to store the data point in a database associated with the map layer, where the map layer comprises the data point and one or more other data points that indicate one or more other locations related to respective autonomous driving transitions for one or more other vehicles.

The computer-executable program code instructions are also configured, in an example embodiment, to generate the data point for the map layer based on probe pattern data associated with a driving path pattern for the vehicle traveling along the road segment. The computer-executable program code instructions are also configured, in an example embodiment, to generate the data point for the map layer based on camera sensor data associated with a second vehicle traveling along the road segment. The computer-executable program code instructions are also configured, in an example embodiment, to generate the data point for the map layer based on lane change data associated with detection of a lane change of the vehicle traveling along the road segment. The computer-executable program code instructions are also configured, in an example embodiment, to generate the data point for the map layer based on at least one of traffic condition data associated with the road segment, weather condition data associated with the road segment, and road event data associated with the road segment.

In another example embodiment, an apparatus is provided that includes means for receiving vehicle context data and location data thereof associated with a vehicle traveling along a road segment, where the vehicle context data is determined based on a transition into a platooning driving profile for the vehicle that establishes a communication connection between the vehicle and another vehicle traveling along the road segment. The apparatus of this example embodiment also includes means for generating a data point for a map layer associated with the road segment based on the vehicle context data and location data, where the data point indicates the transition into the platooning driving profile for the vehicle. The apparatus of this example embodiment also includes means for storing the data point in a database associated with the map layer, where the map layer comprises the data point and one or more other data points that indicate one or more other locations related to respective autonomous driving transitions for one or more other vehicles.

The apparatus of another example embodiment also includes means for generating the data point for the map layer based on probe pattern data associated with a driving path pattern for the vehicle traveling along the road segment. The apparatus of another example embodiment also includes means for generating the data point for the map layer based on camera sensor data associated with a second vehicle traveling along the road segment. The apparatus of another example embodiment also includes means for generating the data point for the map layer based on lane change data associated with detection of a lane change of the vehicle traveling along the road segment. The apparatus of another example embodiment also includes means for generating the data point for the map layer based on at least one of traffic condition data associated with the road segment, weather condition data associated with the road segment, and road event data associated with the road segment.

In an example embodiment, a computer program product is provided to generate an autonomous driving profile map index. The computer program product includes at least one non-transitory computer readable storage medium having computer-executable program code instructions stored therein with the computer-executable program code instructions including program code instructions configured, upon execution, to identify an autonomous driving event and location data thereof associated with a vehicle traveling along a road segment. The computer-executable program code instructions are also configured to determine a platooning driving profile for the vehicle based on the location data and at least one other platooning driving profile for the road segment. In this example, embodiment, the at least one other platooning driving profile is calculated based on vehicle context data for at least one vehicle at the road segment. Also in this example embodiment, the vehicle context data is determined based on at least one transition into the at least one other platooning driving profile that establishes a communication connection between the at least one vehicle and at least one other vehicle traveling along the road segment.

The computer-executable program code instructions in an example embodiment are also configured to facilitate autonomous driving of the vehicles associated with the road segment based on the platooning driving profile. The computer-executable program code instructions in an example embodiment are also configured to facilitate routing of the vehicles associated with the road segment based on the platooning driving profile. The computer-executable program code instructions in an example embodiment are also configured to cause rendering of data via a map display of the vehicle associated with the road segment based on the platooning driving profile.

In another example embodiment, a computer-implemented method is provided for generating an autonomous driving profile map index. The computer-implemented method includes identifying an autonomous driving event and location data thereof associated with a vehicle traveling along a road segment. The computer-implemented method also includes determining a platooning driving profile for the vehicle based on the location data and at least one other platooning driving profile for the road segment. In this example, embodiment, the at least one other platooning driving profile is calculated based on vehicle context data for at least one vehicle at the road segment. Also in this example embodiment, the vehicle context data is determined based on at least one transition into the at least one other platooning driving profile that establishes a communication connection between the at least one vehicle and at least one other vehicle traveling along the road segment.

The computer-implemented method of an example embodiment also includes facilitating autonomous driving of the vehicles associated with the road segment based on the platooning driving profile. The computer-implemented method of an example embodiment also includes facilitating routing of the vehicles associated with the road segment based on the platooning driving profile. The computer-implemented method of an example embodiment also includes causing rendering of data via a map display of the vehicle associated with the road segment based on the platooning driving profile.

In another example embodiment, an apparatus is configured to generate an autonomous driving profile map index. The apparatus includes processing circuitry and at least one memory including computer program code instructions that are configured to, when executed by the processing circuitry, cause the apparatus to identify an autonomous driving event and location data thereof associated with a vehicle traveling along a road segment. The computer program code instructions are also configured to, when executed by the processing circuitry, cause the apparatus to determine a platooning driving profile for the vehicle based on the location data and at least one other platooning driving profile for the road segment. In this example, embodiment, the at least one other platooning driving profile is calculated based on vehicle context data for at least one vehicle at the road segment. Also in this example embodiment, the vehicle context data is determined based on at least one transition into the at least one other platooning driving profile that establishes a communication connection between the at least one vehicle and at least one other vehicle traveling along the road segment.

The computer program code instructions of an example embodiment are also configured to, when executed by the processing circuitry, cause the apparatus to facilitate autonomous driving of the vehicles associated with the road segment based on the platooning driving profile. The computer program code instructions of an example embodiment are also configured to, when executed by the processing circuitry, cause the apparatus to facilitate routing of the vehicles associated with the road segment based on the platooning driving profile. The computer program code instructions of an example embodiment are also configured to, when executed by the processing circuitry, cause the apparatus to cause rendering of data via a map display of the vehicle associated with the road segment based on the platooning driving profile.

In another example embodiment, an apparatus is provided that includes means for identifying an autonomous driving event and location data thereof associated with a vehicle traveling along a road segment. The apparatus of this example embodiment also includes means for determining a platooning driving profile for the vehicle based on the location data and at least one other platooning driving profile for the road segment. In this example, embodiment, the at least one other platooning driving profile is calculated based on vehicle context data for at least one vehicle at the road segment. Also in this example embodiment, the vehicle context data is determined based on at least one transition into the at least one other platooning driving profile that establishes a communication connection between the at least one vehicle and at least one other vehicle traveling along the road segment.

The apparatus of an example embodiment also includes means for facilitating autonomous driving of the vehicles associated with the road segment based on the platooning driving profile. The apparatus of an example embodiment also includes means for facilitating routing of the vehicles associated with the road segment based on the platooning driving profile. The apparatus of an example embodiment also includes means for causing rendering of data via a map display of the vehicle associated with the road segment based on the platooning driving profile.

### BRIEF DESCRIPTION OF THE DRAWINGS

Having thus described certain embodiments of the disclosure in general terms, reference will now be made to the accompanying drawings, which are not necessarily drawn to scale, and wherein:

FIG. 1 is a block diagram of a system including an apparatus for providing an automated driving profile map index for vehicles in accordance with one or more example embodiments of the present disclosure;

FIG. 2 is a flowchart illustrating operations performed, such as by the apparatus of FIG. 1, in order to provide for an automated driving profile map index for vehicles in accordance with one or more example embodiments of the present disclosure;

FIG. 3 illustrates a vehicle with respect to a road segment in accordance with one or more example embodiments of the present disclosure;

FIG. 4 is a block diagram of a system for using vehicle context data and location data to facilitate generation of map data in accordance with one or more example embodiments of the present disclosure;

FIG. 5 illustrates a map divided into autonomous driving profile regions in accordance with one or more example embodiments of the present disclosure;

FIG. 6 illustrates an exemplary road network in accordance with one or more example embodiments of the present disclosure;

FIG. 7 illustrates another exemplary road network in accordance with one or more example embodiments of the present disclosure;

FIG. 8 illustrates an exemplary road segment in accordance with one or more example embodiments of the present disclosure; and

FIG. 9 is an example embodiment of an architecture specifically configured for implementing embodiments described herein.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure can be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms can be used interchangeably to refer to data capable of being transmitted, received and/or stored in accordance with embodiments of the present disclosure. Thus, use of any such terms should not be taken to limit the spirit and scope of embodiments of the present disclosure.

During certain autonomous driving situations, an autonomous vehicle may enter an area of a road segment that generally follows less organized driving methods than provided by lane lines or indicated by signs. Furthermore, in certain autonomous driving situations, a road segment may not include lane lines for an autonomous vehicle to follow. For example, a roundabout during high traffic times in certain locations can be an autonomous driving situation where it appears that numerous vehicles (e.g., cars, motorcycles, scooters, and/or other vehicles) are driving using less organized driving methods. Furthermore, in certain locations, lane lines and/or signs may be ignored by vehicles and an autonomous vehicle will likely still try to follow lane lines, signs and/or other driving rules when vehicles around the autonomous vehicle are not following lane lines, signs and/or other driving rules. Thus, an autonomous vehicle may be unable to efficiently and/or accurately determine how to handle certain autonomous driving situations.

To address these and/or other issues, a method, apparatus and computer program product are provided in accordance with an example embodiment in order to provide an autonomous driving profile map index for vehicles. In an embodiment, data can be collected from vehicles (e.g., autonomous driving vehicles) to facilitate mapping areas (e.g., road segments) along with a calculated degree of variability in a driving path (e.g., a level of chaos) for vehicles in the areas. Accordingly, with this information, prediction of autonomous driving profiles for vehicles in the areas can be improved. Furthermore, in certain embodiments, navigation guidance for a vehicle can be modified based on this information. According to one or more embodiments, it can be determined when a level of autonomous driving mode for a vehicle is changed from a normal driving profile (e.g., a normal autonomous driving profile) to a platooning driving profile (e.g., a platooning autonomous driving profile. The normal driving profile can be an autonomous driving mode for a vehicle that generally adheres to lane lines for road segments, signs associated with road segments and/or other driving rules associated with road segments. The platooning driving profile can be an autonomous driving mode for a vehicle that establishes a communication connection between the vehicle and another vehicle (e.g., a platoon leader vehicle) traveling along the road segment such that the vehicle generally adheres to a driving path of the other vehicle (e.g., the platoon leader vehicle).

According to one or more embodiments, in response to a triggered event, data associated with a vehicle can collected. The collected data can include, for example, location data (e.g., global positioning system (GPS) probe data, etc.), inter vehicle sensor data, intra vehicle sensor data, traffic data (e.g., traffic incident data, etc.), environmental data (e.g., weather data, etc.), special event data (e.g., parades, sporting events, etc.), road event data (e.g., road construction, etc.), and/or other data. In certain embodiments, data associated with multiple vehicles in an area can be collected via crowdsourcing to provide improved autonomous driving predictions for the area.

According to one or more embodiments, the data associated with the vehicles can be uploaded to a mapping server. Furthermore, the data from the vehicles can be aggregated into information to facilitate mapping and/or generating patterns for changes in autonomous driving profiles for vehicles. In certain embodiments, an autonomous driving profile value can be mapped onto a road network and/or a road lane network. For example, in certain embodiments, an autonomous driving profile value can correspond to a number between 0-1 that corresponds to a degree of variability in a driving path (e.g., a level of chaos) for vehicles in the areas. In certain embodiments, different map layers can correspond to different autonomous driving profiles. Additionally, in certain embodiments, a map layer can be generated based on vehicle data such as, for example, a particular make/model of a vehicle, particular autonomous driving capabilities for a vehicle, other vehicle data, etc. According to one or more embodiments, an autonomous driving profile value is a chaos driving index that indicates a level of chaos for a spatial reference point, a link, a segment, and/or a tile associated with a road segment. For example, for a vehicle approaching a roundabout, the chaos driving index can be higher than a vehicle approaching a straight highway associated with normal driving conditions. According to one or more embodiments, an autonomous driving profile value is a scored map index for road links determined based on historical probe data, input from one or more vehicles equipped with one or more sensors, and/or other data. According to one or more embodiments, an autonomous driving profile value indicates how often lane changes occur in a given area over an interval of time, whether evasive actions for vehicles are beneficial for the given area, and/or an observed lack of lane line rules followed by vehicles in the given area. In one or more embodiments, an autonomous driving profile value can prepare drivers and/or autonomous vehicles that it is likely beneficial to at least partially follow one or more surrounding vehicles rather than follow lane lines on a road segment. Additionally or alternatively, an autonomous driving profile value can trigger a certain type of autonomous driving profile (e.g., a more aggressive driving profile, a platooning driving profile, etc.) in order to successfully navigate a road segment (e.g., drive and/or change lanes in the road segment).

Accordingly, an autonomous driving profile map index for vehicles can be employed to provide improved autonomous driving and/or vehicle localization for a vehicle. Moreover, an autonomous driving profile map index for vehicles can provide additional dimensionality and/or advantages for one or more sensors of a vehicle. An autonomous driving profile map index for vehicles can also provide a low cost and/or efficient solution for improved autonomous driving and/or vehicle localization for a vehicle. Computational resources for improved autonomous driving and/or vehicle localization can also be conserved. An autonomous driving profile map index for vehicles can also provide a cost effective and/or efficient solution for improved autonomous driving and/or vehicle localization. Computational resources for improved autonomous driving and/or vehicle localization utilizing an autonomous driving profile map index for vehicles can also be relatively limited in order to allow the computational resources to be utilized for other purposes. An autonomous driving profile map index for vehicles may additionally facilitate improved navigation of a vehicle, improved route guidance for a vehicle, improved semi-autonomous vehicle control, and/or improved fully autonomous vehicle control.

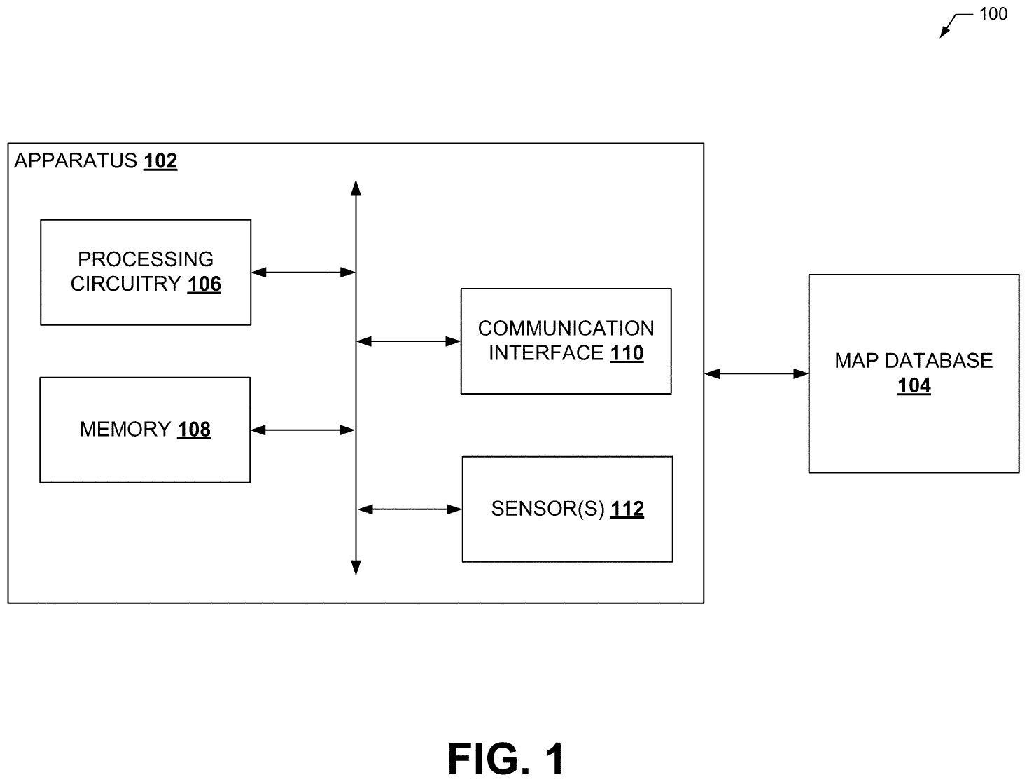

With reference to FIG. 1, a system 100 configured to provide an autonomous driving profile map index for vehicles is depicted, in accordance with one or more embodiments of the present disclosure. In the illustrated embodiment, the system 100 includes an apparatus 102 and a map database 104. As described further below, the apparatus 102 is configured in accordance with an example embodiment of the present disclosure to assist navigation of a vehicle and/or to autonomous driving for a vehicle. The apparatus 102 can be embodied by any of a wide variety of computing devices including, for example, a computer system of a vehicle, a vehicle system of a vehicle, a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System module (ADAS of a vehicle), or any other type of computing device carried by or remote from the vehicle including, for example, a server or a distributed network of computing devices.

In an example embodiment where some level of vehicle autonomy is involved, the apparatus 102 can be embodied or partially embodied by a computing device of a vehicle that supports safety-critical systems such as the powertrain (engine, transmission, electric drive motors, etc.), steering (e.g., steering assist or steer-by-wire), and/or braking (e.g., brake assist or brake-by-wire). However, as certain embodiments described herein may optionally be used for map generation, map updating, and map accuracy confirmation, other embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. Regardless of the type of computing device that embodies the apparatus 102, the apparatus 102 of an example embodiment includes, is associated with or otherwise is in communication with processing circuitry 106, memory 108 and optionally a communication interface 110.

In some embodiments, the processing circuitry 106 (and/or co-processors or any other processors assisting or otherwise associated with the processing circuitry 106) can be in communication with the memory 108 via a bus for passing information among components of the apparatus 102. The memory 108 can be non-transitory and can include, for example, one or more volatile and/or non-volatile memories. In other words, for example, the memory 108 may be an electronic storage device (for example, a computer readable storage medium) comprising gates configured to store data (for example, bits) that can be retrievable by a machine (for example, a computing device like the processing circuitry 106). The memory 108 can be configured to store information, data, content, applications, instructions, or the like for enabling the apparatus 100 to carry out various functions in accordance with an example embodiment of the present disclosure. For example, the memory 108 can be configured to buffer input data for processing by the processing circuitry 106. Additionally or alternatively, the memory 108 can be configured to store instructions for execution by the processing circuitry 106.

The processing circuitry 106 can be embodied in a number of different ways. For example, the processing circuitry 106 may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 106 can include one or more processing cores configured to perform independently. A multi-core processor can enable multiprocessing within a single physical package. Additionally or alternatively, the processing circuitry 106 can include one or more processors configured in tandem via the bus to enable independent execution of instructions, pipelining and/or multithreading.

In an example embodiment, the processing circuitry 106 can be configured to execute instructions stored in the memory 108 or otherwise accessible to the processing circuitry 106. Alternatively or additionally, the processing circuitry 106 can be configured to execute hard coded functionality. As such, whether configured by hardware or software methods, or by a combination thereof, the processing circuitry 106 can represent an entity (for example, physically embodied in circuitry) capable of performing operations according to an embodiment of the present disclosure while configured accordingly. Thus, for example, when the processing circuitry 106 is embodied as an ASIC, FPGA or the like, the processing circuitry 106 can be specifically configured hardware for conducting the operations described herein. Alternatively, as another example, when the processing circuitry 106 is embodied as an executor of software instructions, the instructions can specifically configure the processing circuitry 106 to perform the algorithms and/or operations described herein when the instructions are executed. However, in some cases, the processing circuitry 106 can be a processor of a specific device (for example, a computing device) configured to employ an embodiment of the present disclosure by further configuration of the processor by instructions for performing the algorithms and/or operations described herein. The processing circuitry 106 can include, among other things, a clock, an arithmetic logic unit (ALU) and/or one or more logic gates configured to support operation of the processing circuitry 106.

The apparatus 102 of an example embodiment can also optionally include the communication interface 110 that can be any means such as a device or circuitry embodied in either hardware or a combination of hardware and software that is configured to receive and/or transmit data from/to other electronic devices in communication with the apparatus 102, such as the map database 104 that stores data (e.g., map data, autonomous driving profile data, autonomous level data, location data, geo-referenced locations, sensor data, traffic data, environmental data, road condition data, time data, timestamp data, temporal data, vehicle data, vehicle version data, software version data, hardware version data, vehicle speed data, distance data, vehicle context data, statistical data, other data, etc.) generated and/or employed by the processing circuitry 106. Additionally or alternatively, the communication interface 110 can be configured to communicate in accordance with various wireless protocols including Global System for Mobile Communications (GSM), Long Term Evolution (LTE), fifth-generation (5G), etc. In this regard, the communication interface 110 can include, for example, an antenna (or multiple antennas) and supporting hardware and/or software for enabling communications with a wireless communication network. In this regard, the communication interface 110 can include, for example, an antenna (or multiple antennas) and supporting hardware and/or software for enabling communications with a wireless communication network. Additionally or alternatively, the communication interface 110 can include the circuitry for interacting with the antenna(s) to cause transmission of signals via the antenna(s) or to handle receipt of signals received via the antenna(s). In some environments, the communication interface 110 can alternatively or also support wired communication and/or may alternatively support vehicle to vehicle or vehicle to infrastructure wireless links.

In certain embodiments, the apparatus 102 can be equipped or associated with one or more sensors 112, such as one or more GPS sensors, one or more accelerometer sensors, one or more LiDAR sensors, one or more radar sensors, one or more gyroscope sensors, one or more ultrasonic sensors, one or more infrared sensors and/or one or more other sensors. Any of the one or more sensors 112 may be used to sense information regarding movement, positioning, and/or orientation of the apparatus 102 for use in navigation assistance and/or autonomous vehicle control, as described herein according to example embodiments.

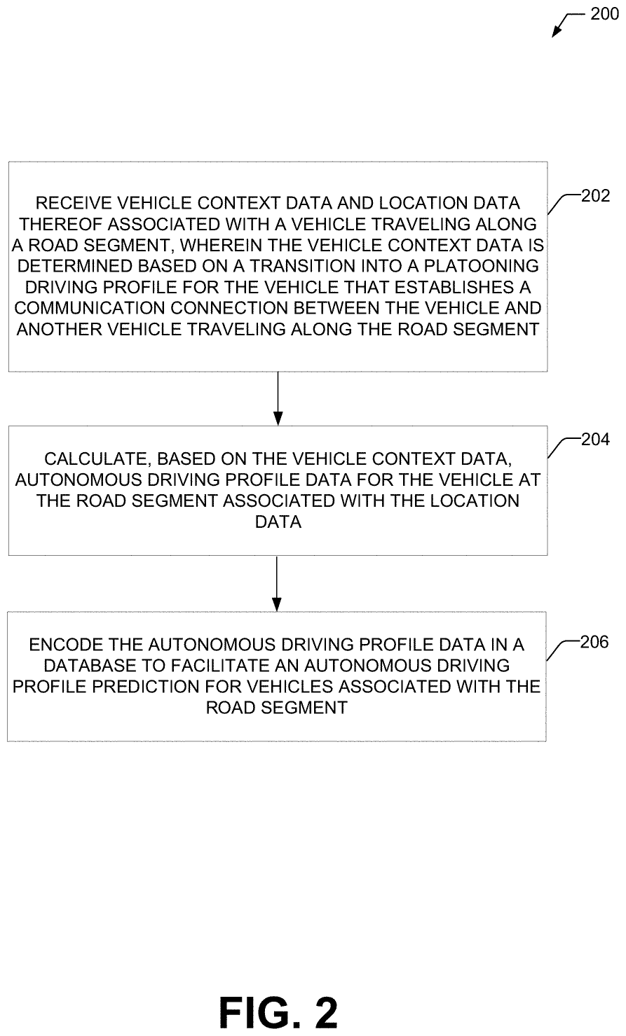

FIG. 2 illustrates a flowchart depicting a method 200 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 108 of the apparatus 102 employing an embodiment of the present disclosure and executed by the processing circuitry 106. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 2, the operations performed, such as by the apparatus 102 of FIG. 1, in order to provide for generating an autonomous driving profile map index are depicted, in accordance with one or more embodiments of the present disclosure. As shown in block 202 of FIG. 2, the apparatus 102 includes means, such as the processing circuitry 106, the memory 108, or the like, configured to receive vehicle context data and location data thereof associated with a vehicle traveling along a road segment, where the vehicle context data is determined based on a transition into a platooning driving profile for the vehicle that establishes a communication connection between the vehicle and another vehicle traveling along the road segment.

In one or more embodiments, the apparatus 102, such as the processing circuitry 106, can be configured to receive the vehicle context data and/or the location data in response to an event associated with the vehicle. For example, in one or more embodiments, the apparatus 102, such as the processing circuitry 106, can be configured to receive the vehicle context data and/or the location data in response to a change in an autonomous driving profile for the vehicle. In an embodiment, the apparatus 102, such as the processing circuitry 106, can be configured to receive the vehicle context data and/or the location data in response to the transition into the platooning driving profile for the vehicle. The platooning driving profile can be associated with an autonomous driving mode in which the vehicle establishes the communication connection with one or more other vehicles (e.g., one or more platoon leader vehicles) traveling along the road segment. In one or more embodiments, the transition into the platooning driving profile for the vehicle can include transitioning from a normal driving profile (e.g., a normal autonomous driving profile) for the vehicle. In one or more embodiments, the normal driving profile for the vehicle can be associated with an autonomous level for the vehicle. For instance, the autonomous level can be indicative of a level of defined autonomy (e.g., a degree of autonomous driving) associated with the vehicle. In certain embodiments, the autonomous level can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In another example, in one or more embodiments, the apparatus 102, such as the processing circuitry 106, can be configured to receive the vehicle context data and/or the location data in response a determination that a certain amount of time has passed since previously obtaining other vehicle context data and/or other location data. For example, the apparatus 102, such as the processing circuitry 106, can be configured to receive the vehicle context data and/or the location data at different time intervals (e.g., every hour, every 30 minutes, every 10 minutes, etc.).

In one or more embodiments, the apparatus 102, such as the processing circuitry 106, can be configured to receive at least a portion of the vehicle context data and/or the location data from the vehicle. Additionally or alternatively, in one or more embodiments, the apparatus 102, such as the processing circuitry 106, can be configured to receive at least a portion of the autonomous level data and/or the location data from a database. In various embodiments, the event and/or the change in the autonomous driving profile for the vehicle can be determined and/or initiated by a processor (e.g., the processing circuitry 106 or other processing circuitry) of the vehicle.

Autonomous driving has become a focus of recent technology with recent advances in machine learning, computer vision, and computing power able to conduct real-time mapping and sensing of a vehicle's environment. Such an understanding of the environment enables autonomous driving in two distinct ways. Primarily, real-time or near real-time sensing of the environment can provide information about potential obstacles, the behavior of others on the roadway, and areas that are navigable by the vehicle. An understanding of the location of other vehicles and/or what the other vehicles have done and may be predicted to do may be useful for a vehicle (or apparatus 102) to safely plan a route.

Autonomous vehicles or vehicles with some level of autonomous controls provide some degree of vehicle control that was previously performed by a person driving a vehicle. Removing some or all of the responsibilities of driving from a person and automating those responsibilities require a high degree of confidence in performing those responsibilities in a manner at least as good as a human driver. For example, maintaining a vehicle's position within a lane by a human involves steering the vehicle between observed lane markings and determining a lane when lane markings are faint, absent, or not visible due to weather (e.g., heavy rain, snow, bright sunlight, etc.). As such, it is desirable for the autonomous vehicle to be equipped with sensors sufficient to observe road features, and a controller that is capable of processing the signals from the sensors observing the road features, interpret those signals, and provide vehicle control to maintain the lane position of the vehicle based on the sensor data. Maintaining lane position is merely one illustrative example of a function of autonomous or semi-autonomous vehicles that demonstrates the sensor level and complexity of autonomous driving. However, autonomous vehicle capabilities, particularly in fully autonomous vehicles, must be capable of performing all driving functions. As such, the vehicles must be equipped with sensor packages that enable the functionality in a safe manner.

The location data can include information associated with a geographic location of the vehicle. For instance, the location data can include geographic coordinates for the vehicle. In an embodiment, the location data can include latitude data and/or longitude data defining the location of the vehicle. In an aspect, the apparatus 102, such as the processing circuitry 106, can receive the location data from the one or more sensors 112. For example, in an embodiment, the apparatus 102, such as the processing circuitry 106, can receive the location data from a GPS or other location sensor of the vehicle. In another embodiment, the apparatus 102, such as the processing circuitry 106, can receive the location data from a LiDAR sensor of the vehicle. In yet another embodiment, the apparatus 102, such as the processing circuitry 106, can receive the location data from one or more ultrasonic sensors and/or one or more infrared sensors of the vehicle. Additionally, in one or more embodiments, the location data can include information associated with the event and/or the change in the autonomous driving profile for the vehicle. In certain embodiments, the location data can include first location associated with a decision by a processor (e.g., the processing circuitry 106 or other processing circuitry) of the vehicle to initiate the change in the autonomous driving profile for the vehicle. Additionally or alternatively, the location data can include second location data associated with execution of the change in the autonomous driving profile by a processor (e.g., the processing circuitry 106 or other processing circuitry) of the vehicle.

The vehicle context data can include data associated with the vehicle, data associated with one or more vehicles proximate to the vehicle, and/or data associated with the road segment. In one or more embodiments, the vehicle context data can provide context related to the transition into the platooning driving profile for the vehicle. Furthermore, the vehicle context data can include real-time vehicle context data and/or historical vehicle context data. According to one or more embodiments, the vehicle context data includes probe pattern data, sensor data, camera sensor data, lane change data, traffic condition data, weather condition data, road event data, time data, vehicle data, vehicle version data, and/or other vehicle context data. The probe pattern data can be associated with a driving path pattern for the vehicle traveling along the road segment. For example, in one or more embodiments, the probe pattern data can provide an indication as to how often the vehicle stays in road lanes and/or how often the vehicle changes lanes. In an example, the driving path pattern for the vehicle can correspond to an approximate straight line pattern and/or curved line pattern when the vehicle stays in road lanes. However, when the vehicle often changes lanes, the driving path pattern for the vehicle can correspond to an approximate spaghetti line pattern. The sensor data can be associated with the vehicle and/or at least a second vehicle traveling along the road segment. For instance, in one or more embodiments, the sensor data can include intra vehicle sensor data provided by one or more sensors of the vehicle. Additionally or alternatively, in one or more embodiments, the sensor data can include inter vehicle sensor data provided by one or more sensors of one or more vehicles proximate to the vehicle. In one or more embodiments, the sensor data can include camera sensor data associated with the vehicle and/or at least a second vehicle traveling along the road segment. However, it is to be appreciated that the sensor data can additionally or alternatively include one or more other types of sensor data associated with the vehicle and/or at least a second vehicle traveling along the road segment.

In one or more embodiments, the apparatus 102, such as the processing circuitry 106, can be configured to employ the intra vehicle sensor data (e.g., intra vehicle camera sensor data) to detect vehicle lane changes and/or vehicle cutoffs associated with the vehicle. In one or more embodiments, the apparatus 102, such as the processing circuitry 106, can be configured to employ the intra vehicle sensor data in combination with map data (e.g., lane-level map data) to detect vehicle lane changes and/or vehicle cutoffs associated with the vehicle. For example, in one or more embodiments, the apparatus 102, such as the processing circuitry 106, can be configured to generate, based on the intra vehicle sensor data, lane change data associated with detection of a lane change of the vehicle traveling along a road segment. In one or more embodiments, the apparatus 102, such as the processing circuitry 106, can be configured to additionally or alternatively employ the inter vehicle sensor data (e.g., inter vehicle camera sensor data) to detect vehicle lane changes and/or vehicle cutoffs associated with the vehicle. For example, in one or more embodiments, the apparatus 102, such as the processing circuitry 106, can be configured to generate, based additionally or alternatively on the inter vehicle sensor data, lane change data associated with detection of a lane change of the vehicle traveling along a road segment. In one or more embodiments, one or more vehicles proximate to the vehicle can be configured for vehicle lane change detection and/or vehicle cutoff detection that detects evasive maneuvers such as lane changes associated with other vehicles, hard braking of other vehicles, rapid acceleration of other vehicles, hard turns by other vehicles, and/or other maneuvers different than normal driving maneuvers. For instance, in one or more embodiments, one or more vehicles proximate to the vehicle can observe vehicle lane changes occurring proximate the one or vehicles and can provide an indication of the lane changes to the apparatus 102 and/or a server associated with the apparatus 102.

The traffic condition data can be associated with the road segment. For example, the traffic condition data can include information related to traffic conditions such as, but not limited to, high vehicle traffic conditions, traffic incident information (e.g., vehicle accidents, broken-down vehicles, etc.), other traffic condition information, etc. In one or more embodiments, the traffic condition data can be associated with location data and/or timestamp data for respective traffic conditions and/or respective traffic incidents. In one or more embodiments, the apparatus 102, such as the processing circuitry 106, can be configured to correlate the traffic condition data with lane changes and/or chaotic driving maneuvers associated with vehicles. The weather condition data can be associated with the road segment. For instance, the weather condition data can include information related to one or more weather conditions associated with the road segment. In an example, the weather condition data can provide information related to a slippery road or puddles that causes vehicles to change lanes. In one or more embodiments, the weather condition data can include information related to real-time weather conditions and/or historical weather conditions. In one or more embodiments, the weather condition data can be associated with location data and/or timestamp data for respective weather conditions. The road event data can be associated with the road segment. For instance, the road event data can include information related to special events (e.g., parades, sporting events, special events where lanes are chicane, road closures, lane merges, lane narrowing, etc.) and/or road events (e.g., road work, road construction, etc.). The time data can be associated with the change in the autonomous driving profile for the vehicle. In one or more embodiments, the apparatus 102, such as the processing circuitry 106, can be configured to receive first time data associated with the decision to initiate the change in the autonomous driving profile for the vehicle. Additionally or alternatively, in one or more embodiments, the apparatus 102, such as the processing circuitry 106, can be configured to receive second time data associated with the execution of the change in the autonomous driving profile for the vehicle. The vehicle version data can be associated with one or more components of the vehicle that facilitate autonomous driving of the vehicle. The vehicle data can be associated with a vehicle type for the vehicle.

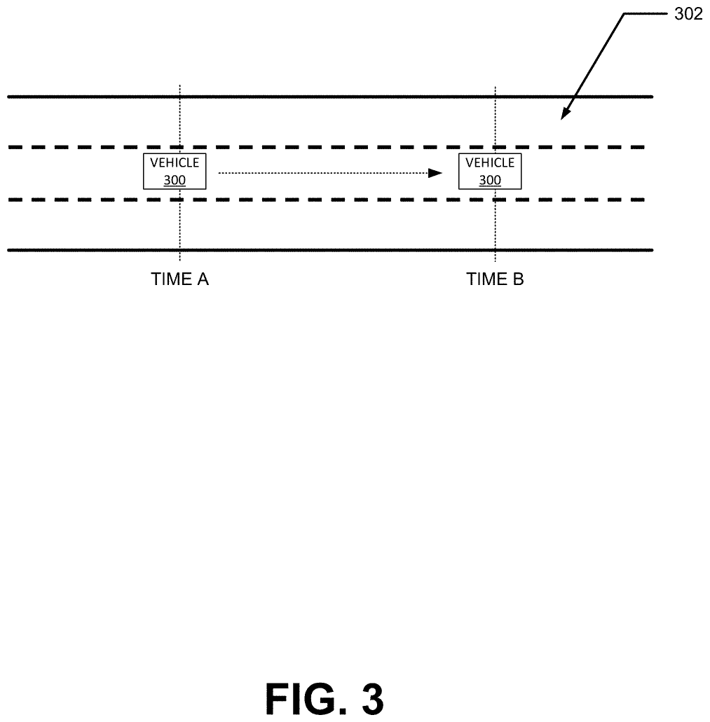

An example of the vehicle associated with the road segment is depicted in FIG. 3. As shown in FIG. 3, a vehicle 300 travels along a road segment 302. In one or more embodiments, the vehicle 300 can be an automobile where tires of the vehicle 300 are in contact with a road surface of the road segment 302. In an exemplary embodiment, the vehicle 300 can be associated with a first autonomous driving profile (e.g., a normal driving profile) at a first time (e.g., TIME A shown in FIG. 3). Furthermore, at the first time (e.g., TIME A), the vehicle 300 can be associated with a first location (e.g., a particular latitude and/or longitude). In certain embodiments, the vehicle 300 (e.g., a processor of the vehicle 300) can initiate a change in the autonomous driving profile for the vehicle 300. For example, at the first time (e.g., TIME A shown in FIG. 3), the vehicle 300 can initiate the change in the autonomous driving profile. Additionally, at a second time (e.g., TIME B shown in FIG. 3), the vehicle 300 can be associated with a second autonomous driving profile (e.g., the platooning driving profile). Furthermore, at the second time (e.g., TIME B), the vehicle 300 can be associated with a second location (e.g., a different latitude and/or longitude).

As shown in block 204 of FIG. 2, the apparatus 102 includes means, such as the processing circuitry 106, the memory 108, or the like, configured to calculate, based on the vehicle context data, autonomous driving profile data for the vehicle at the road segment associated with the location data. For example, in one or more embodiments, the apparatus 102, such as the processing circuitry 106, can be configured to calculate the autonomous driving profile data for the vehicle based on the probe pattern data, the sensor data, the camera sensor data, the lane change data, the traffic condition data, the weather condition data, the road event data, the time data, the vehicle data, the vehicle version data, and/or other vehicle context data. In an embodiment, the autonomous driving profile data can be an autonomous driving profile map index (e.g., a chaos driving index).

An exemplary calculation for an autonomous driving profile map index p(v) is shown below:

p(\vec{v})=ΣwᵢN(vᵢ)/ΣwᵢN_{Ti},

where wᵢ is a weight corresponding to an i^{th} input source, N(vᵢ) is a number of input occurrences at a region of interest, and N_{Ti} is a total possible occurrence for each intersection. In one or more embodiments, the apparatus 102, such as the processing circuitry 106, can be configured to periodically determine an autonomous driving profile map index for a given region of interest (e.g., every hour, every 30 minutes, every 10 minutes, etc.). In certain embodiments where one or more portions of the vehicle context data is unavailable, then historical data for the same time epoch can be considered.

In one or more embodiments, the apparatus 102, such as the processing circuitry 106, can be configured to apply a weight to different portions of the vehicle context data. In one or more embodiments, the respective weights can be determined based on ground truth data. For example, in a scenario where 10 locations are identified as ground truth locations of chaotic driving, the weights for each attribute can be related to the frequency of the attribute existence at the 10 locations. In one or more embodiments, the apparatus 102, such as the processing circuitry 106, can be configured to transform one or more portions of the vehicle context data into Boolean values. The Boolean values can, for example, represent activities at a region of interest. For example, a Boolean value can indicate whether or not a certain type of vehicle context data is available. In one or more embodiments, an event can be assigned a weight that reflects a degree of influence for the autonomous driving profile map index. In an exemplary embodiment, probe pattern data, inter vehicle sensor data, intra vehicle sensor data, traffic condition data, weather condition data, special event data, and road event data can be weighted by the apparatus 102, such as the processing circuitry 106. In certain embodiments, the summation of respective weights can be equal to 1.

In a non-limiting example, for a given region of interest (e.g., a given road segment, a given spatial reference point, a given link, etc.), probe pattern data can be assigned a Boolean value equal to “TRUE,” inter vehicle sensor data can be assigned a Boolean value equal to “TRUE,” intra vehicle sensor data can be assigned a Boolean value equal to “TRUE,” traffic condition data can be assigned a Boolean value equal to “TRUE,” weather condition data can be assigned a Boolean value equal to “FALSE,” special event data can be assigned a Boolean value equal to “FALSE,” and road event data can be assigned a Boolean value equal to “FALSE.” Furthermore, probe pattern data, inter vehicle sensor data, traffic condition data, weather condition data, special event data, and road event data can be assigned a weighted value of 0.1 and intra vehicle sensor data can be assigned a weighted value of 0.4. Therefore, the autonomous driving profile map index p(v) in this example can be equal to:

$$p ( \vec{v} ) = \frac{1 * 0.4 + ( 1 * 0.1 ) * 3}{0.4 + 6 * 0.1} = \frac{0.7}{1} \text{∼} 0.7 .$$

In another non-limiting example, for a given region of interest (e.g., a given road segment, a given spatial reference point, a given link, etc.), probe pattern data can be assigned a Boolean value equal to “FALSE,” inter vehicle sensor data can be assigned a Boolean value equal to “TRUE,” intra vehicle sensor data can be assigned a Boolean value equal to “TRUE,” traffic condition data can be assigned a Boolean value equal to “TRUE,” weather condition data can be assigned a Boolean value equal to “FALSE,” special event data can be assigned a Boolean value equal to “FALSE,” and road event data can be assigned a Boolean value equal to “FALSE.” Furthermore, probe pattern data, inter vehicle sensor data, traffic condition data, weather condition data, special event data, and road event data can be assigned a weighted value of 0.1 and intra vehicle sensor data can be assigned a weighted value of 0.4. Therefore, the autonomous driving profile map index p(v) in this example can be equal to:

$$p ( \vec{v} ) = \frac{1 * 0.4 + ( 1 * 0.1 ) * 1}{0.4 + 6 * 0.1} = \frac{0.5}{1} \text{∼} 0.5 .$$

In certain embodiments, the apparatus 102, such as the processing circuitry 106, can be configured to apply a time decay value to the autonomous driving profile map index. For example, if certain types of vehicle context data is not updated (e.g., due to lack of vehicle coverage or third-party services such as weather becoming unavailable), the apparatus 102, such as the processing circuitry 106, can be configured to apply a time decay to a previously calculated autonomous driving profile map index. As such, in certain embodiments, the autonomous driving profile map index p(v) can be equal to:

p(\vec{v},t)=e^{-t/T}p(\vec{v}),

where T is time, v is a set of input properties of the vehicle context data, t is a parameter controlling how fast the autonomous driving profile map index value decays (e.g., for static portions of a road segment). In one or more embodiments, t can be a constant equal to 1.

In an example where the autonomous driving profile map index p(v) is equal to 0.7 at time T=0 (e.g., current time), the autonomous driving profile map index p(v) can be equal to 0.69 at time T=60 (e.g., 60 minutes after the current time) since 0.7 e^{-1/160}=0.69. In another example where the autonomous driving profile map index p(v) is equal to 0.5 at time T=0 (e.g., current time), the autonomous driving profile map index p(v) can be equal to 0.49 at time T=60 (e.g., 60 minutes after the current time) since 0.5 e^{-1/160}=0.49.

In certain embodiments, the apparatus 102, such as the processing circuitry 106, can be configured to determine a classification for the autonomous driving profile map index. For example, in one or more embodiments, the apparatus 102, such as the processing circuitry 106, can be configured to predict whether the autonomous driving profile map index for a given region of interest is temporary, semi-temporary or permanent. In certain embodiments, the apparatus 102, such as the processing circuitry 106, can be configured to apply a weight to the autonomous driving profile map index based on the classification for the autonomous driving profile map index.

In one or more embodiments, the apparatus 102, such as the processing circuitry 106, can be configured to aggregate the autonomous driving profile data with the other autonomous driving profile data based on the location data. For example, in one or more embodiments, the apparatus 102, such as the processing circuitry 106, can be configured to aggregate autonomous driving profile data with similar location. In an embodiment, the apparatus 102, such as the processing circuitry 106, can be configured to aggregate autonomous driving profile data from two or more vehicles in response to a determination that the two or more vehicles are within a predefined distance of a location associated with a change in an autonomous level for the two or more vehicles. In another embodiment, the apparatus 102, such as the processing circuitry 106, can be configured to aggregate autonomous driving profile data from two or more vehicles in response to a determination that the two or more vehicles are within a corresponding region of interest (e.g., a corresponding area associated with a road segment and/or a geographic region). In an embodiment, the apparatus 102, such as the processing circuitry 106, can be configured to aggregate, based on a spatial reference point associated with the location data, the autonomous driving profile data with other autonomous driving profile data for one or more other vehicles at the spatial reference point to generate aggregated autonomous driving profile data for the road segment. In another embodiment, the apparatus 102, such as the processing circuitry 106, can be configured to aggregate, based the location data, the autonomous driving profile data with other autonomous driving profile data for one or more other vehicles at respective spatial reference points associated with the road segment to generate aggregated autonomous driving profile data for the road segment

In one or more embodiments, the apparatus 102, such as the processing circuitry 106, can be configured to aggregate the autonomous driving profile data with the other autonomous driving profile data based on time data. For example, in one or more embodiments, the apparatus 102, such as the processing circuitry 106, can be configured to aggregate autonomous driving profile data with similar timing information (e.g., a similar time of day, a similar day of week, a similar season, etc.). In an embodiment, the apparatus 102, such as the processing circuitry 106, can be configured to aggregate autonomous driving profile data from two or more vehicles in response to a determination that time data for the two or more vehicles are deemed to be similar. In one or more embodiments, the apparatus 102, such as the processing circuitry 106, can be configured to aggregate the autonomous driving profile data with the other autonomous driving profile data based on vehicle data. For example, in one or more embodiments, the apparatus 102, such as the processing circuitry 106, can be configured to aggregate autonomous driving profile data with similar a similar make and/or a similar model. In an embodiment, the apparatus 102, such as the processing circuitry 106, can be configured to aggregate autonomous driving profile data from two or more vehicles in response to a determination that the two or more vehicles are a same vehicle make and/or a same vehicle model. In one or more embodiments, the apparatus 102, such as the processing circuitry 106, can be configured to aggregate the autonomous driving profile data with the other autonomous driving profile data based on vehicle version data. For example, in one or more embodiments, the apparatus 102, such as the processing circuitry 106, can be configured to aggregate autonomous driving profile data with a same vehicle software version related to autonomous driving. In an embodiment, the apparatus 102, such as the processing circuitry 106, can be configured to aggregate autonomous driving profile data from two or more vehicles in response to a determination that the two or more vehicles comprise a same software version (e.g., same firmware version) and/or same hardware related to autonomous driving.

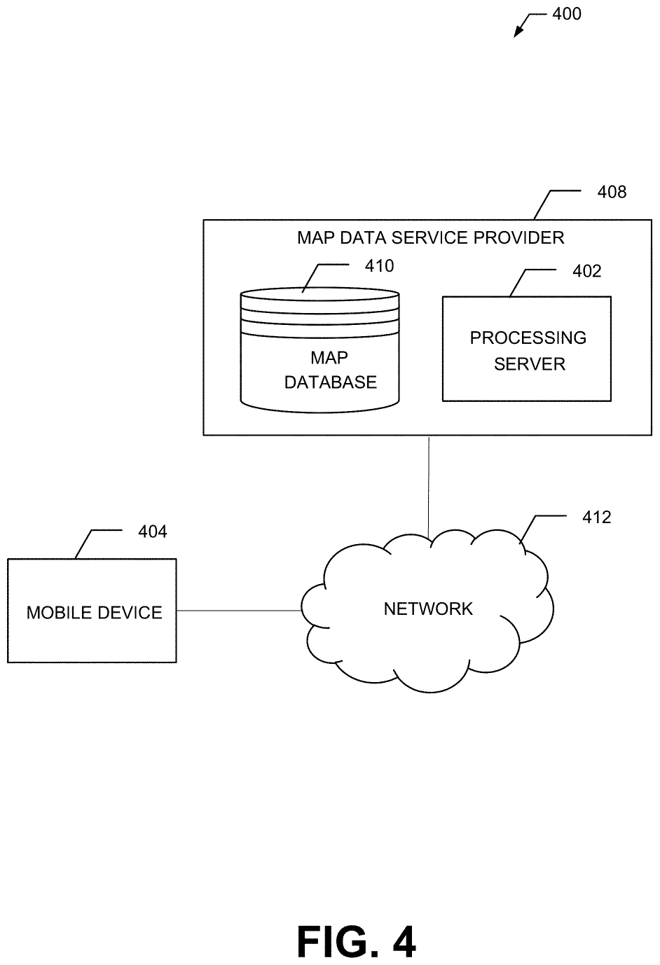

In certain embodiments, to facilitate generation of the autonomous driving profile data for the road segment, the apparatus 102 can support a mapping, navigation, and/or autonomous driving application so as to present maps or otherwise provide navigation or driver assistance, such as in an example embodiment in which map data is created or updated using methods described herein. For example, the apparatus 102 can provide for display of a map and/or instructions for following a route within a network of roads via a user interface (e.g., a graphical user interface). In order to support a mapping application, the apparatus 102 can include or otherwise be in communication with a geographic database, such as map database 104, a geographic database stored in the memory 108, and/or map database 410 shown in FIG. 4. For example, the geographic database can include node data records, road segment or link data records, point of interest (POI) data records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology can be used, such as electronic horizon sensors, radar, LiDAR, ultrasonic sensors and/or infrared sensors. In one or more embodiments, the other autonomous level data can be stored in the map database 104, the map database 410, and/or another database accessible by the apparatus 102.

In example embodiments, a navigation system user interface and/or an autonomous driving user interface can be provided to provide driver assistance to a user traveling along a network of roadways where data collected from the vehicle (e.g., the vehicle 300) associated with the navigation system user interface can aid in establishing a position of the vehicle along a road segment (e.g., the road segment 302) and/or can provide assistance for autonomous or semi-autonomous vehicle control of the vehicle. Autonomous vehicle control can include driverless vehicle capability where all vehicle functions are provided by software and hardware to safely drive the vehicle along a path identified by the vehicle. Semi-autonomous vehicle control can be any level of driver assistance from adaptive cruise control, to lane-keep assist, or the like. Establishing vehicle location and position along a road segment can provide information useful to navigation and autonomous or semi-autonomous vehicle control by establishing an accurate and highly specific position of the vehicle on a road segment and even within a lane of the road segment such that map features in the map, e.g., a high definition (HD) map, associated with the specific position of the vehicle can be reliably used to aid in guidance and vehicle control.

A map service provider database can be used to provide driver assistance, such as via a navigation system and/or through an Advanced Driver Assistance System (ADAS) having autonomous or semi-autonomous vehicle control features. Referring back to FIG. 4, illustrated is a communication diagram of an example embodiment of a system for implementing example embodiments described herein. The illustrated embodiment of FIG. 4 includes a mobile device 404, which can be, for example, the apparatus 102 of FIG. 1, such as a mobile phone, an in-vehicle navigation system, an ADAS, or the like. The illustrated embodiment of FIG. 4 also includes a map data service provider 408. The mobile device 404 and the map data service provider 408 can be in communication via a network 412. The network 412 can be any form of wireless or partially wireless network as will be described further below. Additional, different, or fewer components can be provided. For example, many mobile devices 404 can connect with the network 412. In an embodiment, the map data service provider can be a cloud service. For instance, in certain embodiments, the map data service provider 408 can provide cloud-based services and/or can operate via a hosting server that receives, processes, and provides data to other elements of the system 400.

The map data service provider 408 can include a map database 410 that can include node data, road segment data or link data, point of interest (POI) data, traffic data or the like. In one embodiment, the map database 410 can be different than the map database 104. In another embodiment, at least a portion of the map database 410 can correspond to the map database 104. The map database 410 can also include cartographic data, routing data, and/or maneuvering data. According to some example embodiments, the road segment data records can be links or segments representing roads, streets, or paths, as can be used in calculating a route or recorded route information for determination of one or more personalized routes. The node data can be end points (such as representing intersections) corresponding to the respective links or segments of road segment data. The road link data and the node data can represent a road network, such as used by vehicles, cars, trucks, buses, motorcycles, and/or other entities. Optionally, the map database 410 can contain path segment and node data records or other data that can represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 410 can include data about the POIs and their respective locations in the POI records. The map database 410 can include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 410 can include event data (e.g., traffic incidents, construction activities, scheduled events, unscheduled events, etc.) associated with the POI data records or other records of the map database 410.

The map database 410 can be maintained by the map data service provider 408 and can be accessed, for example, by a processing server 402 of the map data service provider 408. By way of example, the map data service provider 408 can collect geographic data and/or dynamic data to generate and enhance the map database 410. In one example, the dynamic data can include traffic-related data. There can be different ways used by the map data service provider 408 to collect data. These ways can include obtaining data from other sources, such as municipalities or respective geographic authorities, such as via global information system databases. In addition, the map data service provider 408 can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that can be available is vehicle data provided by vehicles, such as provided, e.g., as probe points, by mobile device 404, as they travel the roads throughout a region.

In certain embodiments, at least a portion of the map database 104 can be included in the map database 410. In an embodiment, the map database 410 can be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems. For example, geographic data can be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 404, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 410 of the map data service provider 408 can be a master geographic database, but in alternate embodiments, a client side map database can represent a compiled navigation database that can be used in or with end user devices (e.g., mobile device 404) to provide navigation and/or map-related functions. For example, the map database 410 can be used with the mobile device 404 to provide an end user with navigation features. In such a case, the map database 410 can be downloaded or stored on the end user device which can access the map database 410 through a wireless or wired connection, such as via a processing server 402 and/or the network 412, for example.

In one embodiment, as noted above, the end user device or mobile device 404 can be embodied by the apparatus 102 of FIG. 1 and can include an ADAS which can include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, a server and/or other device that can perform navigation-related functions, such as digital routing and map display. An end user can use the mobile device 404 for navigation and map functions such as guidance and map display, for example, and for determination of useful driver assistance information, according to some example embodiments.

In certain embodiments, the apparatus 102, such as the processing circuitry 106, can be configured to aggregate the autonomous driving profile data with other autonomous driving profile data based on a density-based clustering technique, such as, for example, density-based spatial clustering of applications with noise (DB-SCAN). For example, in one or more embodiments, the apparatus 102, such as the processing circuitry 106, can be configured to aggregate locations associated with a change in an autonomous driving profile via distance using the DB-SCAN. In an embodiment, the apparatus 102, such as the processing circuitry 106, can be configured to employ a first input parameter (e.g., the minimum number of vehicles required to form a road segment region) and/or a second input parameter (e.g., the distance between the vehicles for the vehicles to be considered related) to form a cluster.

In one or more embodiments, the apparatus 102, such as the processing circuitry 106, can be configured to generate an autonomous driving profile region based on a cluster. The autonomous driving profile region can be a region of one or more road segments where an autonomous driving profile for vehicles is likely to change. In certain embodiments, the apparatus 102, such as the processing circuitry 106, can be configured to designate a cluster as an autonomous driving profile region in response to a determination that a minimum number of vehicles is within the autonomous driving profile region. Furthermore, the apparatus 102, such as the processing circuitry 106, can be configured to employ criterion associated with distance to determine an autonomous driving profile region. For example, the apparatus 102, such as the processing circuitry 106, can be configured to initially set an autonomous driving profile region to correspond to 30 meters in size. Furthermore, in certain embodiments, the apparatus 102, such as the processing circuitry 106, can be configured to dynamically alter a size of the autonomous driving profile region based on a number of vehicles in the autonomous driving profile region and/or other conditions associated with the autonomous driving profile region. In an embodiment, the autonomous driving profile region can correspond to a geometric shape that is spatially represented as, for example, a point, a line, a polygon, or another geometric shape.

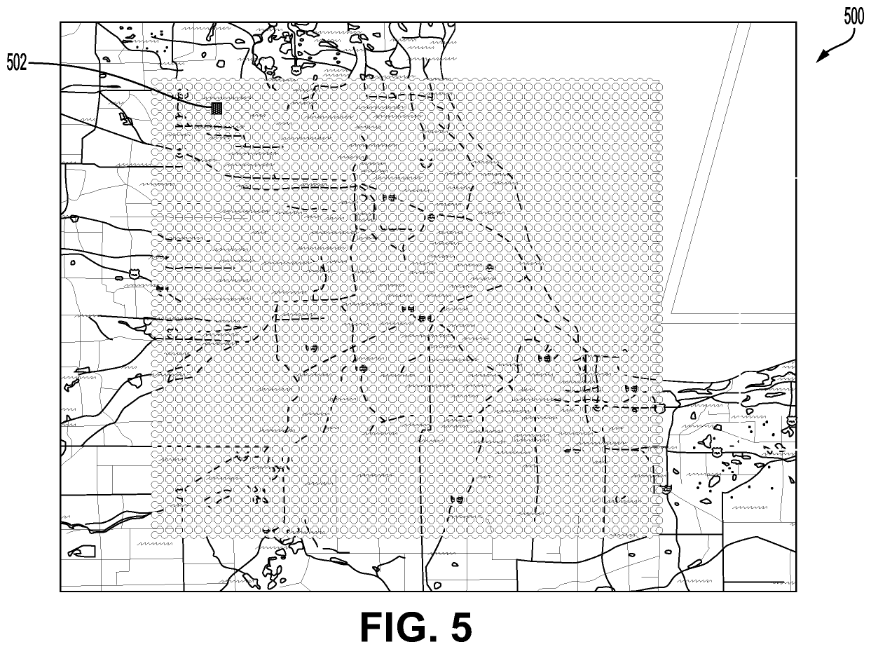

FIG. 5 illustrates a map 500 divided into autonomous driving profile regions. For example, the map 500 includes at least an autonomous driving profile region 502. The autonomous driving profile region 502 can be, for example, a region associated with a certain level of driving chaos. In an embodiment, the autonomous driving profile region 502 can be a tile cell or a grid cell. In a non-limiting example, the autonomous driving profile region 502 can be a 2 kilometer by 2 kilometer tile cell. However, it is to be appreciated that the autonomous driving profile region 502 can be a different shape and/or a different size. In one or more embodiments, the apparatus 102, such as the processing circuitry 106, can be configured to determine a transition confidence value for the autonomous driving profile region 502 per time epoch (e.g., every hour, every 15 minutes, etc.). In certain embodiments, the apparatus 102, such as the processing circuitry 106, can be configured to calculate transition confidence values for respective autonomous driving profile regions based on different time epochs. For example, the apparatus 102, such as the processing circuitry 106, can be configured to calculate a transition confidence value for the autonomous driving profile region 502 using a particular time epoch and another transition confidence value for another autonomous driving profile region using a different time epoch. In one or more embodiments, the apparatus 102, such as the processing circuitry 106, can be configured to calculate a transition confidence value for the autonomous driving profile region 502 based on a number of vehicles that change an autonomous level during the time epoch, a freshness (e.g., temporal dimension) of transition confidence data from vehicles, a distance of a vehicle from a centroid of the autonomous driving profile region 502, a transition vehicle trustworthiness score (e.g., based on a vehicle make or model), and/or other data associated with the autonomous driving profile region 502 and/or vehicles within the autonomous driving profile region 502.

As shown in block 206 of FIG. 2, the apparatus 102 includes means, such as the processing circuitry 106, the memory 108, or the like, configured to encode the autonomous driving profile data in a database to facilitate an autonomous driving profile prediction for vehicles associated with the road segment. For example, in one or more embodiments, the aggregated autonomous driving profile data can be encoded into the map database 104, the map database 410, and/or another database accessible by the apparatus 102. In one or more embodiments, the aggregated autonomous driving profile data can be encoded in a database based on a format of the aggregated autonomous driving profile data shown in FIG. 5. For example, in one or more embodiments, the aggregated autonomous driving profile data can be encoded in a database based on location, vehicle make/model, aggregated autonomous driving profile classification, time epoch, version information and/or autonomous driving profile transition reason. In certain embodiments, the apparatus 102, such as the processing circuitry 106, can be configured to convert the aggregated autonomous driving profile data into a format for storage and/or categorization by the database. In certain embodiments, the apparatus 102, such as the processing circuitry 106, can be configured to additionally encode the transition confidence value in the database to facilitate the autonomous driving profile prediction for the vehicles associated with the road segment. In one or more embodiments, the apparatus 102, such as the processing circuitry 106, can be configured to generate and/or update transition pattern data (e.g., autonomous driving profile transition data) for a map layer associated with the road segment based on the transition confidence value. For example, in one or more embodiments, the apparatus 102, such as the processing circuitry 106, can be configured to generate and/or update transition pattern data (e.g., autonomous driving profile transition data) associated with historical data for the road segment. In one or more embodiments, the apparatus 102, such as the processing circuitry 106, can be configured to combine real-time transition data for the road segment with historical transition patterns (e.g., historical driving profile transition patterns) for the road segment.

In certain embodiments, the apparatus 102, such as the processing circuitry 106, can be configured to map the aggregated autonomous driving profile data onto one or more map data layers of a map (e.g., an HD map) to facilitate the autonomous level prediction for the vehicles. For instance, in certain embodiments, the apparatus 102, such as the processing circuitry 106, can be configured to store the aggregated autonomous driving profile data in a map data layer of a map (e.g., an HD map) for mapping purposes, navigation purposes, and/or autonomous driving purposes. In certain embodiments, the apparatus 102, such as the processing circuitry 106, can be configured to store the aggregated autonomous driving profile data in two or more map data layer of a map (e.g., an HD map) for mapping purposes, navigation purposes, and/or autonomous driving purposes. For example, in an embodiment, aggregated autonomous driving profile data for a first type of vehicle model can be stored in a first map data layer, aggregated autonomous driving profile data for a second type of vehicle model can be stored in a second map data layer, etc. Additionally or alternatively, in an embodiment, aggregated autonomous driving profile data for a first location can be stored in a first map data layer, aggregated autonomous driving profile data for a second location can be stored in a second map data layer, etc. Additionally or alternatively, in an embodiment, aggregated autonomous driving profile data for a first time or date can be stored in a first map data layer, aggregated autonomous driving profile data for a second time or date can be stored in a second map data layer, etc. Additionally or alternatively, in an embodiment, aggregated autonomous driving profile data for a first type of vehicle version can be stored in a first map data layer, aggregated autonomous driving profile data for a second type of vehicle version can be stored in a second map data layer, etc. Additionally or alternatively, in an embodiment, aggregated autonomous driving profile data for a first type of reason can be stored in a first map data layer, aggregated autonomous driving profile data for a second type of reason can be stored in a second map data layer, etc. Additionally or alternatively, in an embodiment, aggregated autonomous driving profile data for vehicles traveling in a first direction with respect to a road segment can be stored in a first map data layer, aggregated autonomous driving profile data for vehicles traveling in a first direction with respect to a road segment can be stored in a second map data layer, etc. In certain embodiments, the apparatus 102, such as the processing circuitry 106, can be configured to link and/or associate the aggregated autonomous driving profile data with one or more portions, components, areas, layers, features, text, symbols, and/or data records of a map (e.g., an HD map).

In one or more embodiments, the apparatus 102, such as the processing circuitry 106, can be configured to generate a data point for a map layer associated with the road segment based on the autonomous driving profile data and the location data. The data point can indicate the transition of the autonomous driving profile for the vehicle and/or a location associated with the transition of the autonomous driving profile for the vehicle. Additionally or alternatively, in one or more embodiments, the apparatus 102, such as the processing circuitry 106, can be configured to store the data point in the database associated with the map layer. The map layer can include the data point and one or more other data points that indicate one or more other locations related to respective autonomous driving profile transitions for one or more other vehicles associated with the road segment. In certain embodiments, the apparatus 102, such as the processing circuitry 106, can be configured to aggregate the data point with another data point of the map layer in response to a determination that a distance between the data point and the other data point satisfies a defined criterion.

In one or more embodiments, the apparatus 102, such as the processing circuitry 106, can be configured to generate one or more road links (e.g., one or more map-matched road links) for the road segment to facilitate an autonomous driving profile prediction for vehicles associated with the road segment. For instance, in one or more embodiments, the apparatus 102, such as the processing circuitry 106, can be configured to map a calculated value onto a road network map. In certain embodiments, the calculated value can correspond to a number between 0-1. For instance, in certain embodiments, the calculated value (e.g., the number between 0-1) can correspond to a percentage chance of likelihood to demonstrate autonomous driving profile prediction. In an aspect, the apparatus 102, such as the processing circuitry 106, can be configured to map the calculated value based on a type of autonomous driving profile. In an example, a first map layer for the road segment can indicate a calculated value for a predicted first autonomous driving profile, a second map layer for the road segment can indicate a calculated value for a predicted second autonomous driving profile, etc. In one or more embodiments, a calculated value for the autonomous level prediction can be generated based on vehicle context data, autonomous driving profile data, location data, time data, vehicle version data, vehicle data, vehicle context data and/or other data included in the aggregated autonomous driving profile data. In an embodiment, a calculated value for the autonomous driving profile prediction can be an automated driving profile map index.

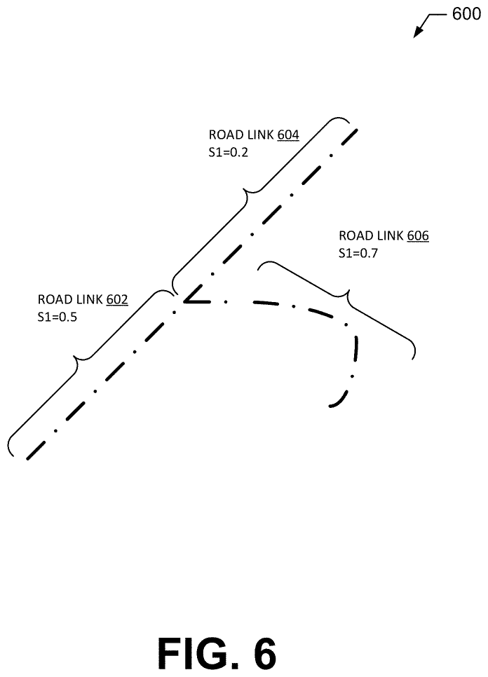

An example of a road network is depicted in FIG. 6. As shown in an exemplary embodiment of FIG. 6, a road network 600 includes a first road segment 602, a second road segment 604, and a third road segment 606. In an aspect, the road segment 602 includes a map layer that provides a calculated value for an autonomous driving profile map index that corresponds to 0.5 (e.g., a 50% level of chaos), the road segment 604 includes a map layer that provides a calculated value for an autonomous driving profile map index that corresponds to 0.2 (e.g., a 20% level of chaos), and the road segment 606 includes a map layer that provides a calculated value for an autonomous driving profile map index that corresponds to 0.7 (e.g., a 70% level of chaos).

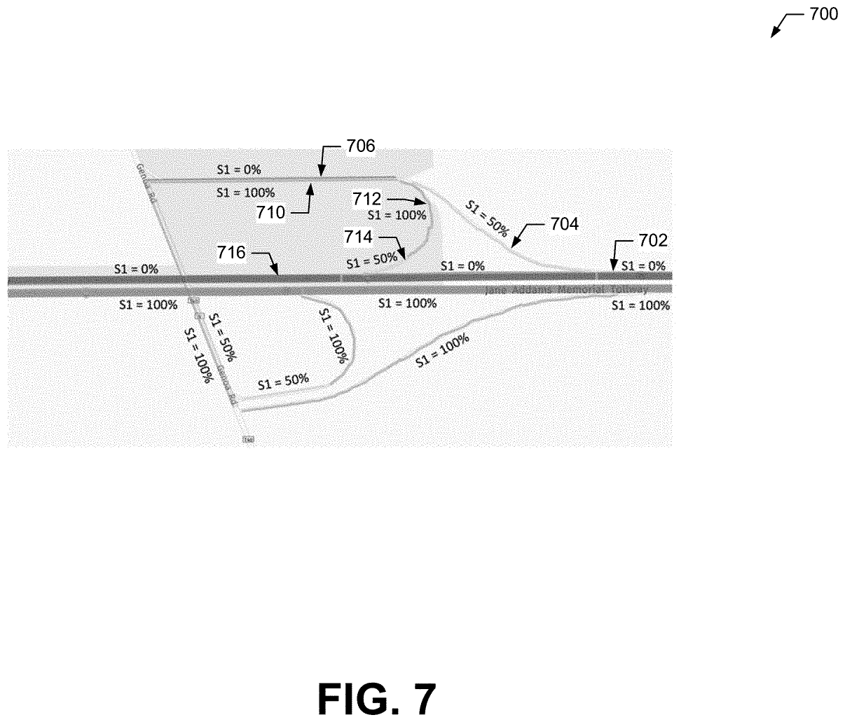

Another example of a road network is depicted in FIG. 7. As shown in an exemplary embodiment of FIG. 7, a road network 700 includes a first road segment 702, a second road segment 704, and a third road segment 706 associated with a direction of travel. In an aspect, the road segment 702 includes a map layer that provides a calculated value for an autonomous driving profile map index that corresponds to a 0% level of chaos (e.g., S1=0%), the road segment 704 includes a map layer that provides a calculated value for an autonomous driving profile map index that corresponds to a 50% level of chaos (e.g., S1=50%), and the road segment 706 includes a map layer that provides a calculated value for an autonomous driving profile map index that corresponds to a 0% level of chaos (e.g., S1=0%). As shown FIG. 7, the road network 700 also includes a fourth road segment 710, a fifth road segment 712, a sixth road segment 714, and a seventh road segment 716 associated with a different direction of travel than the first road segment 702, the second road segment 704 and the third road segment 706. In an aspect, the road segment 710 includes a map layer that provides a calculated value for an autonomous driving profile map index that corresponds to a 100% level of chaos (e.g., S1=100%), the road segment 712 includes a map layer that provides a calculated value for an autonomous driving profile map index that corresponds to a 100% level of chaos (e.g., S1=100%), the road segment 714 includes a map layer that provides a calculated value for an autonomous driving profile map index that corresponds to a 50% level of chaos (e.g., S1=50%), and the road segment 716 includes a map layer that provides a calculated value for an autonomous driving profile map index that corresponds to a 0% level of chaos (e.g., S1=0%).

In one or more embodiments, the apparatus 102, such as the processing circuitry 106, can be configured to generate an alert event based on the autonomous driving profile data and/or the aggregated autonomous driving profile data. For example, in an embodiment, the apparatus 102, such as the processing circuitry 106, can be configured to create a new chaotic driving event in response to a determination that a value of the autonomous driving profile data and/or the aggregated autonomous driving profile data is above a defined threshold for a given region of interest. In another embodiment, the apparatus 102, such as the processing circuitry 106, can be configured to cancel a chaotic driving event in response to a determination that a value of the autonomous driving profile data and/or the aggregated autonomous driving profile data drops below a defined threshold for a given region of interest. In one or more embodiments, the apparatus 102, such as the processing circuitry 106, can be configured to compare autonomous driving profile data and/or aggregated autonomous driving profile data between different locations (e.g., for analytic purposes between the different locations, etc.). In certain embodiments, the apparatus 102, such as the processing circuitry 106, can be configured to apply a weight to autonomous driving profile data and/or aggregated autonomous driving profile data based on the comparison between the different locations.

In one or more embodiments, the apparatus 102, such as the processing circuitry 106, can be additionally or alternatively configured to facilitate routing of one or more vehicles associated with the road segment based on the aggregated autonomous driving profile data (e.g., the automated driving profile map index). In one or more embodiments, the apparatus 102, such as the processing circuitry 106, can be additionally or alternatively configured to facilitate routing of one or more vehicles associated with the road segment based on user feedback provided in response to an indication to a user of a vehicle that the aggregated autonomous driving profile data (e.g., the automated driving profile map index) for the road segment satisfies a defined criterion (e.g., that the aggregated autonomous driving profile data for the road segment indicates a high level of chaos). In one or more embodiments, the apparatus 102, such as the processing circuitry 106, can be additionally or alternatively configured to cause rendering of data via a map display of one or more vehicles associated with the road segment and/or another road segment based on the aggregated autonomous driving profile data (e.g., the automated driving profile map index) for the road segment. For example, in one or more embodiments, the apparatus 102, such as the processing circuitry 106, can be additionally or alternatively configured to render a certain type of visual indicator (e.g., a red color, a green color, a yellow color, etc.) via a map display of one or more vehicles associated with the road segment and/or another road segment based on the aggregated autonomous driving profile data (e.g., the automated driving profile map index) for the road segment.

In one or more embodiments, the aggregated autonomous driving profile data encoded in the database can be employed by one or more other vehicles to facilitate autonomous driving for the one or more vehicles. In one or more embodiments, one or more notifications can be provided to a display of a vehicle based on the aggregated autonomous driving profile data encoded in the database. For example, in response to a determination that a particular road segment has a high level of reduction of autonomous driving level, then a notification can be generated to advise that other vehicles will be reducing a level of autonomy. In one or more embodiments, a vehicle can employ the aggregated autonomous driving profile data encoded in the database to determine a risk level for autonomous driving by the vehicle. For example, in response to a determination that there are three vehicles in proximity with in a road segment and all vehicles are highly capable of driving autonomously, then the road segment may be considered a safer area than if all vehicles detected are more likely to reduce an autonomous driving level. In certain embodiments, an autonomous driving control of a vehicle can determine that the vehicle should pull over and stop on a side of a road in response to a determination that particular aggregated autonomous driving profile data encoded in the database satisfies a defined rationed associated with a defined risk level. In certain embodiments, a recommendation for an infrastructure improvement for a road segment can be generated based on the aggregated autonomous driving profile data encoded in the database.

In one or more embodiments, the apparatus 102, such as the processing circuitry 106, can be additionally or alternatively configured to trigger one or more events based on the aggregated autonomous driving profile data (e.g., the automated driving profile map index). For example, in an embodiment, the apparatus 102, such as the processing circuitry 106, can be configured to trigger an event that requests a driver of an autonomous vehicle to take over driving of the vehicle. In another embodiment, the apparatus 102, such as the processing circuitry 106, can be configured to trigger an event that switches a driving mode of a vehicle to a more aggressive driving mode that, for example, incorporates following one or more vehicles more closely than lane lines, making more aggressive lane changes, allow more cut-off maneuvers by other vehicles, etc. In another embodiment, the apparatus 102, such as the processing circuitry 106, can be configured to trigger an event that initiates a “cut-off” strategy for the vehicle. In another embodiment, the apparatus 102, such as the processing circuitry 106, can be configured to trigger an event that communicates a driving mode of the vehicle to one or more other vehicles. In another embodiment, the apparatus 102, such as the processing circuitry 106, can be configured to trigger an event such that more advanced sensors (e.g., LIDAR, advanced video feeds, radar, etc.) are employed by the vehicle as the vehicle approaches a particular road segment area so that the vehicle is more aware of surroundings and able to react more quickly. In another embodiment, the apparatus 102, such as the processing circuitry 106, can be configured to trigger an event that warns passengers in a vehicle of an upcoming chaos area of a road segment. For example, the apparatus 102, such as the processing circuitry 106, can be configured to trigger a seat belt alert, trigger seat belt monitoring, set a comfort level for the vehicle, provide one or more warning notifications via a display and/or speakers of the vehicle (e.g., to not drink hot coffee, etc.). In another embodiment, the apparatus 102, such as the processing circuitry 106, can be configured to trigger an event that request remote monitoring (e.g., control room monitoring) for a chaos area of a road segment. In yet another embodiment, the apparatus 102, such as the processing circuitry 106, can be configured to trigger an event that assign a risk factor to one or more vehicles and/or adapt a cut-off strategy for a vehicle based on the respective risk factors for the vehicles.

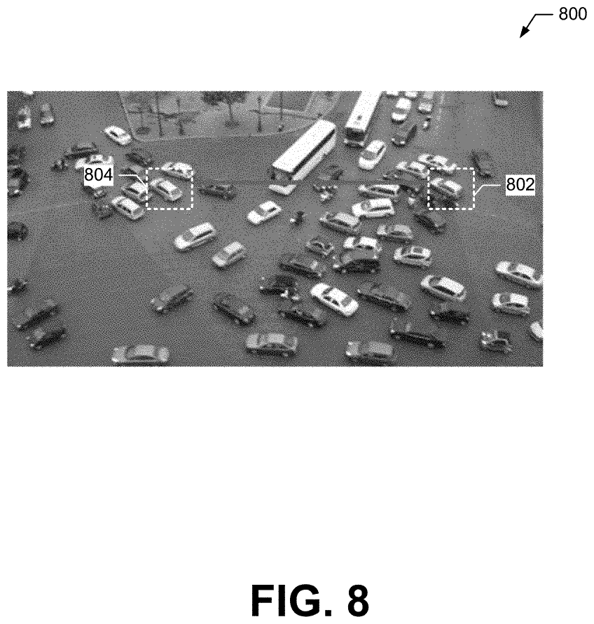

FIG. 8 illustrates a road segment 800 associated with transition of an autonomous driving profile for a vehicle. For example, the road segment 800 can be associated with a roundabout during high traffic where numerous vehicles (e.g., cars, motorcycles, scooters, and/or other vehicles) are driving using less organized driving methods. Furthermore, lane lines and/or signs may be ignored by one or more vehicles on the road segment 800. According to one or more embodiments, a level of autonomous driving mode for a vehicle 802 travelling along the road segment 800 is changed from a normal driving profile (e.g., a normal autonomous driving profile) to a platooning driving profile (e.g., a platooning autonomous driving profile. The normal driving profile can be an autonomous driving mode for the vehicle 802 that generally adheres to lane lines for road segments, signs associated with road segments and/or other driving rules associated with road segments. In an embodiment, the platooning driving profile can be an autonomous driving mode for the vehicle 802 that establishes a communication connection between the vehicle 802 and a vehicle 804 (e.g., a platoon leader vehicle) traveling along the road segment 800 such that the vehicle 802 generally adheres to a driving path of the vehicle 804 (e.g., the platoon leader vehicle). In another embodiment, the platooning driving profile can be a virtual platooning mode such that the vehicle 802 generally adheres to common point (e.g., a common node, a common location, etc.) between a driving path of the vehicle 802 and a driving path of another vehicle (e.g., a virtual vehicle or the vehicle 804).

In an exemplary embodiment, the vehicle 800 can correspond to the vehicle 300. In one or more embodiments, the apparatus 102, such as the processing circuitry 106, can be configured to receive vehicle context data and location data thereof associated with the vehicle 802. The vehicle context data can be determined, for example, based on the transition into the platooning driving profile for the vehicle 802. Additionally, in one or more embodiments, the apparatus 102, such as the processing circuitry 106, can be configured to calculate, based on the vehicle context data, autonomous driving profile data for the vehicle 802 at the road segment 800. The apparatus 102, such as the processing circuitry 106, can be additionally configured to encode the autonomous driving profile data in a database to facilitate an autonomous driving profile prediction for other vehicles associated with the road segment 800.

In one or more embodiments, the apparatus 102, such as the processing circuitry 106, can be configured to generate a data point for a map layer associated with the road segment 800 based on the vehicle context data and location data. The data point can indicate, for example, the transition into the platooning driving profile for the vehicle 802. In one or more embodiments, the apparatus 102, such as the processing circuitry 106, can be additionally configured to store the data point in a database associated with the map layer. The map layer can comprise the data point and one or more other data points that indicate one or more other locations related to respective autonomous driving transitions for one or more other vehicles. In one or more embodiments, the apparatus 102, such as the processing circuitry 106, can be configured to generate the data point for the map layer based on probe pattern data associated with a driving path pattern for the vehicle 802 traveling along the road segment 800, camera sensor data associated with a second vehicle (e.g., the vehicle 804) traveling along the road segment 800, lane change data associated with detection of a lane change of the vehicle 802 traveling along the road segment 800, traffic condition data associated with the road segment 800, weather condition data associated with the road segment 800, road event data associated with the road segment 800, special event data associated with the road segment 800, and/or other vehicle context data.

In one or more embodiments, the apparatus 102, such as the processing circuitry 106, can be configured to identify an autonomous driving event and location data thereof associated with the vehicle 802 traveling along the road segment 800. Additionally, in one or more embodiments, the apparatus 102, such as the processing circuitry 106, can be configured to determine a platooning driving profile for the vehicle 802 based on the location data and at least one other platooning driving profile for the road segment 800. In one or more embodiments, the apparatus 102, such as the processing circuitry 106, can be configured to calculate the at least one other platooning driving profile based on vehicle context data for at least one vehicle at the road segment 800. Furthermore, in one or more embodiments, the apparatus 102, such as the processing circuitry 106, can be configured to determine the vehicle context data based on at least one transition into the at least one other platooning driving profile that establishes a communication connection between the at least one vehicle and at least one other vehicle traveling along the road segment 800. Additionally or alternatively, in one or more embodiments, the apparatus 102, such as the processing circuitry 106, can be configured to determine a platooning driving profile for the vehicle 802 based on the location data and aggregated platooning driving profiles for the road segment 800. In one or more embodiments, the aggregated platooning driving profiles can be calculated based on aggregated vehicle context data for vehicles at the road segment 800. Furthermore, the aggregated vehicle context data can be determined based on respective transitions into respective platooning driving profiles for the vehicles that establish respective communication connections between the vehicles and one or more other vehicles traveling along the road segment 800. In one or more embodiments, the apparatus 102, such as the processing circuitry 106, can be configured to facilitate autonomous driving of one or more vehicles associated with the road segment 800 based on the platooning driving profile. In one or more embodiments, the apparatus 102, such as the processing circuitry 106, can be configured to facilitate routing of one or more associated with the road segment 800 based on the platooning driving profile. In one or more embodiments, the apparatus 102, such as the processing circuitry 106, can be configured to cause rendering of data via a map display of one or more vehicles (e.g., the vehicle 802 and/or one or more different vehicles) associated with the road segment 800 based on the platooning driving profile.

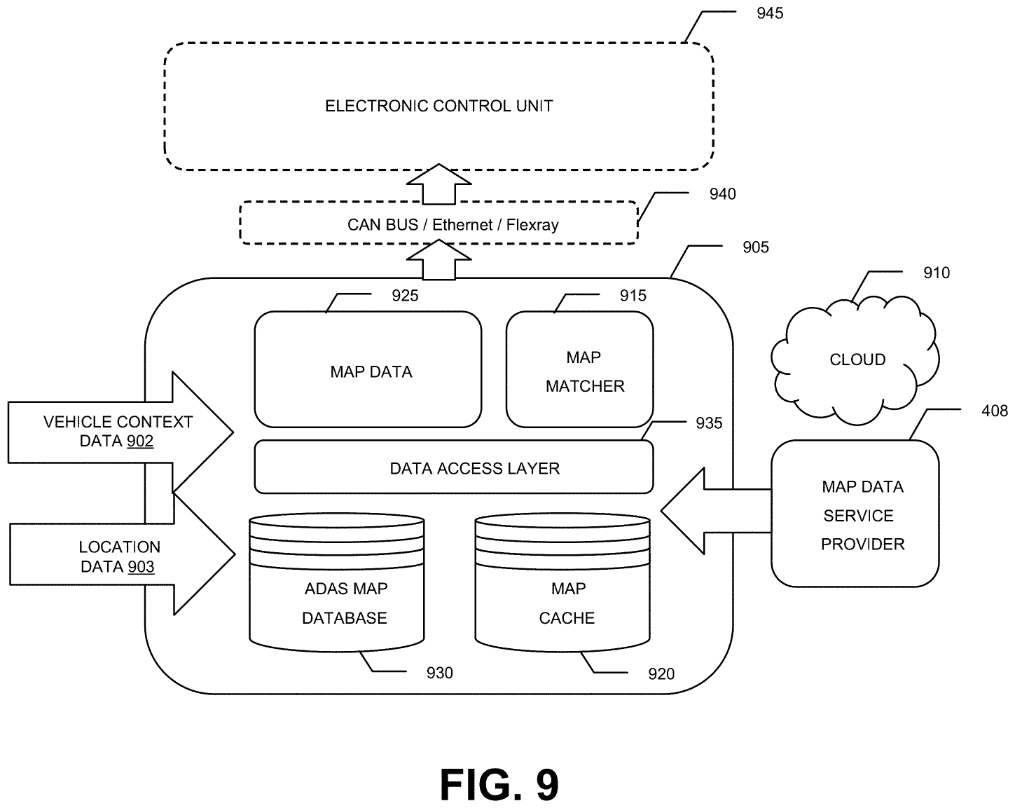

FIG. 9 illustrates an example embodiment of an architecture specifically configured for implementing embodiments described herein. The illustrated embodiment of FIG. 9 may be vehicle-based, where vehicle context data 902 is obtained from one or more vehicles (e.g., the vehicle 300) traveling along a road segment (e.g., the road segment 302). Additionally or alternatively location data 903 can be obtained from the one or more vehicles using GPS or other localization techniques and correlated to map data of the map data service provider 408. A vehicle with autonomous or semi-autonomous control may establish accurate location and/or improved autonomous driving functionality through the vehicle context data 902 and/or the location data 903 to facilitate the autonomous or semi-autonomous control.

As illustrated in FIG. 9, the architecture includes the map data service provider 408 that provides map data 925 (e.g., HD maps and policies associated with road links within the map) to an Advanced Driver Assistance System (ADAS) 905, which may be vehicle-based or server based depending upon the application. The map data service provider 408 may be a cloud-based 910 service. In one or more embodiments, the ADAS 905 receives the location data 903 (e.g., navigation information and/or vehicle position) and may provide the location data 903 to map matcher 915. The map matcher 915 may correlate the vehicle position to a road link on a map of the mapped network of roads stored in the map cache 920. This link or segment, along with the direction of travel, may be used to establish which HD map policies are applicable to the vehicle associated with the ADAS 905, including sensor capability information, autonomous functionality information, etc. Accordingly, policies for the vehicle are established based on the current location and the environmental conditions (e.g., traffic, time of day, weather). The map data 925 associated with the road segment specific to the vehicle are provided to the vehicle control, such as via the CAN (computer area network) BUS (or Ethernet or Flexray) 940 to the electronic control unit (ECU) 945 of the vehicle to implement HD map policies, such as various forms of autonomous or assisted driving, or navigation assistance. In certain embodiments, a data access layer 935 can manage and/or facilitate access to the map cache 920, the map data 925, and/or an ADAS map database 930. In an embodiment, at least a portion of the ADAS map database 930 can correspond to the map database 104 and/or the map database 410.

By employing an automated driving profile map index for vehicles in accordance with one or more example embodiments of the present disclosure, precision and/or confidence of vehicle localization and/or autonomous driving for a vehicle (e.g., the vehicle 300) can be improved. Furthermore, by employing an automated driving profile map index for vehicles in accordance with one or more example embodiments of the present disclosure, improved navigation of a vehicle can be provided, improved route guidance for a vehicle can be provided, improved semi-autonomous vehicle control can be provided, improved fully autonomous vehicle control can be provided, and/or improved safety of a vehicle can be provided. Moreover, in accordance with one or more example embodiments of the present disclosure, efficiency of an apparatus including the processing circuitry can be improved and/or the number of computing resources employed by processing circuitry can be reduced. In one or more embodiments, by employing an automated driving profile map index for vehicles in accordance with one or more example embodiments of the present disclosure, improved statistical information for a road segment can be provided to provide improved recommendations for infrastructure improvements.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Furthermore, in some embodiments, additional optional operations can be included. Modifications, additions, or amplifications to the operations above can be performed in any order and in any combination.

Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

That which is claimed:

1. A computer-implemented method for generating an autonomous driving profile map index, the computer-implemented method comprising:
receiving vehicle context data and location data thereof associated with a vehicle traveling along a road segment, wherein the vehicle context data is determined based on a transition into a platooning driving profile for the vehicle that establishes a communication connection between the vehicle and another vehicle traveling along the road segment;
calculating, based on the vehicle context data, autonomous driving profile data for the vehicle at the road segment associated with the location data; and
encoding the autonomous driving profile data in a database to facilitate an autonomous driving profile prediction for vehicles associated with the road segment.

2. The computer-implemented method of claim 1, wherein the encoding the autonomous driving profile data in the database comprises mapping the autonomous driving profile data onto a map data layer of a high-definition map to facilitate the autonomous driving profile prediction for the vehicles.

3. The computer-implemented method of claim 1, further comprising:
aggregating, based on a spatial reference point associated with the location data, the autonomous driving profile data with other autonomous driving profile data for one or more other vehicles at the spatial reference point to generate aggregated autonomous driving profile data for the road segment.

4. The computer-implemented method of claim 1, further comprising:
aggregating, based the location data, the autonomous driving profile data with other autonomous driving profile data for one or more other vehicles at respective spatial reference points associated with the road segment to generate aggregated autonomous driving profile data for the road segment.

5. The computer-implemented method of claim 1, wherein the calculating the autonomous driving profile data for the vehicle comprises calculating the autonomous driving profile data for the vehicle based on probe pattern data associated with a driving path pattern for the vehicle traveling along the road segment.

6. The computer-implemented method of claim 1, wherein the vehicle is a first vehicle, and wherein the calculating the autonomous driving profile data for the vehicle comprises calculating the autonomous driving profile data for the vehicle based on camera sensor data associated with a second vehicle traveling along the road segment.

7. The computer-implemented method of claim 1, wherein the calculating the autonomous driving profile data for the vehicle comprises calculating the autonomous driving profile data for the vehicle based on lane change data associated with detection of a lane change of the vehicle traveling along the road segment.

8. The computer-implemented method of claim 1, wherein the calculating the autonomous driving profile data for the vehicle comprises calculating the autonomous driving profile data for the vehicle based on traffic condition data associated with the road segment.

9. The computer-implemented method of claim 1, wherein the calculating the autonomous driving profile data for the vehicle comprises calculating the autonomous driving profile data for the vehicle based on weather condition data associated with the road segment.

10. The computer-implemented method of claim 1, wherein the calculating the autonomous driving profile data for the vehicle comprises calculating the autonomous driving profile data for the vehicle based on road event data associated with the road segment.

11. The computer-implemented method of claim 1, wherein the calculating the autonomous driving profile data for the vehicle comprises applying a weight to different portions of the vehicle context data.

12. An apparatus configured to generate an autonomous driving profile map index, the apparatus comprising processing circuitry and at least one memory including computer program code instructions, the computer program code instructions configured to, when executed by the processing circuitry, cause the apparatus to:
receive vehicle context data and location data thereof associated with a vehicle traveling along a road segment, wherein the vehicle context data is determined based on a transition into a platooning driving profile for the vehicle that establishes a communication connection between the vehicle and another vehicle traveling along the road segment;
generate a data point for a map layer associated with the road segment based on the vehicle context data and location data, wherein the data point indicates the transition into the platooning driving profile for the vehicle; and
store the data point in a database associated with the map layer, wherein the map layer comprises the data point and one or more other data points that indicate one or more other locations related to respective autonomous driving transitions for one or more other vehicles.

13. The apparatus of claim 12, wherein the computer program code instructions are further configured to, when executed by the processing circuitry, cause the apparatus to generate the data point for the map layer based on probe pattern data associated with a driving path pattern for the vehicle traveling along the road segment.

14. The apparatus of claim 12, wherein the vehicle is a first vehicle, and wherein the computer program code instructions are further configured to, when executed by the processing circuitry, cause the apparatus to generate the data point for the map layer based on camera sensor data associated with a second vehicle traveling along the road segment.

15. The apparatus of claim 12, wherein the computer program code instructions are further configured to, when executed by the processing circuitry, cause the apparatus to generate the data point for the map layer based on lane change data associated with detection of a lane change of the vehicle traveling along the road segment.

16. The apparatus of claim 12, wherein the computer program code instructions are further configured to, when executed by the processing circuitry, cause the apparatus to generate the data point for the map layer based on at least one of traffic condition data associated with the road segment, weather condition data associated with the road segment, and road event data associated with the road segment.

17. A computer program product comprising at least one non-transitory computer-readable storage medium having computer-executable program code instructions stored therein, the computer-executable program code instructions comprising program code instructions to:
identify an autonomous driving event and location data thereof associated with a vehicle traveling along a road segment; and
determine a platooning driving profile for the vehicle based on the location data and at least one other platooning driving profile for the road segment, wherein the at least one other platooning driving profile is calculated based on vehicle context data for at least one vehicle at the road segment, and wherein the vehicle context data is determined based on at least one transition into the at least one other platooning driving profile that establishes a communication connection between the at least one vehicle and at least one other vehicle traveling along the road segment.

18. The computer program product of claim 17, further comprising program code instructions to facilitate autonomous driving of the vehicles associated with the road segment based on the platooning driving profile.

19. The computer program product of claim 17, further comprising program code instructions to facilitate routing of the vehicles associated with the road segment based on the platooning driving profile.

20. The computer program product of claim 17, further comprising program code instructions to cause rendering of data via a map display of the vehicle associated with the road segment based on the platooning driving profile.
